(19) United States
(12) Patent Application Publication
(10) Pub. No.: US 2009/0294300 A1
(43) Pub. Date: Dec. 3, 2009

(54) RF SYSTEMS AND METHODS FOR PROCESSING SALT WATER

(75) Inventors: John Kanzius, Erie, PA (US); Mary Ann Kanzius, Erie, PA (US)

Correspondence Address: CALFEE HALTER & GRISWOLD, LLP, 800 SUPERIOR AVENUE, SUITE 1400, CLEVELAND, OH, 44114, US

(73) Assignee: KC ENERGY, LLC, Erie, PA (US)

(21) Appl. No.: 12/398,646

(22) Filed: Mar. 5, 2009

Related U.S. Application Data
(60) Provisional application No. 61/033,962, filed on Mar. 5, 2008.

(51) Int. Cl. C02F 1/469

(52) U.S. Cl. 205/687

(57) ABSTRACT

Systems and methods for processing salt water and/or solutions containing salt water with RF energy. Exemplary systems and methods may use RF energy to combust salt water, to produce hydrogen from salt water or solutions containing salt water, to volatilize a secondary fuel present in solutions containing salt water, to produce and combust hydrogen obtained from salt water or solutions containing salt water, to volatilize and combust secondary fuel sources present in solutions containing salt water, to desalinate seawater, and/or to carry out the electrolysis of water are presented. An exemplary system may comprise a reservoir for containing a salt water solution or salt water mixture; a reaction chamber having an inlet; a feed line operatively connecting the reservoir to the inlet of the reaction chamber; an RF transmitter having an RF generator in circuit communication with a transmission head, the RF generator capable of generating an RF signal absorbable by the salt water solution or the salt water mixture having a frequency for transmission via the transmission head; and an RF receiver; wherein the reaction chamber is positioned such that some of the salt water solution or salt water mixture is positioned between the RF transmission head and the RF receiver.

### RELATED CASES

This application claims priority to, and any other benefit of, U.S. Provisional Patent Application No. 61/033,962, filed Mar. 5, 2008 and entitled “RF SYSTEMS AND METHODS FOR PROCESSING MATERIALS,” which is herein incorporated by reference. This case is related to U.S. patent application Ser. No. 11/939,225 of Kanzius, filed Nov. 13, 2007, and entitled RF SYSTEMS AND METHODS FOR PROCESSING SALT WATER, (Attorney Docket 32403/04004); PCT Patent Application Serial No. PCT/U.S.07/84541 of Kanzius and Roy, filed Nov. 13, 2007, and entitled RF SYSTEMS AND METHODS FOR PROCESSING SALT WATER, (Attorney Docket 32403/04003); U.S. Provisional Patent Application Ser. No. 60/865,530 of Kanzius, filed Nov. 13, 2006, and entitled RF SYSTEM AND METHODS FOR PROCESSING SALT WATER (Attorney Docket 30064/04004) (“the '530 application”); U.S. Provisional Patent Application Ser. No. 60/938,613. of Kanzius, filed May 17, 2007, and entitled RF SYSTEM AND METHODS FOR PROCESSING SALT WATER II (Attorney Docket 30064/04008) (“the '613 application”); U.S. Provisional Patent Application Ser. No. 60/953,829 of Kanzius, filed Aug. 3, 2007, entitled RF SYSTEM AND METHODS FOR PROCESSING SALT WATER III (Attorney Docket 30064/04009); U.S. patent application Ser. No. 12/036,731 of Kanzius, filed on Feb. 25, 2008, and entitled FIELD GENERATOR FOR TARGETED CELL ABLATION (Attorney Docket 30274/04034); and U.S. Provisional Patent Application Ser. No. 60/915,345 of Kanzius, filed on May 1, 2007, and entitled FIELD GENERATOR FOR TARGETED CELL ABLATION (Attorney Docket 30274/04036), the entire disclosures of which, including all appendices, diagrams, figures, and photographs of which, are hereby incorporated by reference in their entireties.

### FIELD OF THE INVENTION

The present invention relates to systems and methods for processing water utilizing radio frequency (RF) energy, such as, for example, RF systems and methods for combustion of salt water and/or solutions containing salt water, RF systems and methods for desalinating seawater, RF systems and methods for heating seawater, salt water, and/or solutions containing salt water, RF systems and methods for generating steam, RF systems and methods for volatilizing secondary fuels, RF systems and methods for the electrolysis of salt water and salt water mixtures, RF systems and methods for producing hydrogen from salt water and/or solutions containing salt water, RF systems and methods for combustion of volatiles produced from solutions containing salt water, and/or RF systems and methods for combustion of hydrogen produced from salt water and/or solutions containing salt water.

### BACKGROUND OF THE INVENTION

Hydrogen gas is combustible and is therefore a potentially viable fuel source particularly for use in internal combustion engines. Water can be a source of hydrogen gas and unlike crude oil, which is used to produce gasoline, water and particularly seawater has an advantage over crude oil in that it is present on earth in great abundance. Furthermore, the burning of hydrogen produces water, an environmentally clean byproduct. Many other volatile organic compounds, such as ethanol for example, are also combustible and so they too are potentially viable fuel sources for use in internal combustion engines. Likewise, ethanol has an advantage over crude oil in that ethanol can be synthesized from fermentation of corn, sugar cane or other agricultural products and it is therefore a renewable resource, while by contrast crude oil is not.

### BRIEF DESCRIPTION OF THE DRAWINGS

FIGS. 1-7 are high-level block diagrams of exemplary RF systems for RF processing of salt water and/or solutions containing salt water, such as combusting salt water or solutions containing salt water, generating steam from salt water, producing and collecting hydrogen from salt water or solutions containing salt water, and desalinating seawater;

FIGS. 8A-8C, 9A-9C are various views of exemplary RF transmission and RF reception heads;

FIGS. 10-12, 16, and 16a are schematic diagrams of exemplary RF circuits for exemplary RF systems for RF processing of salt water and/or solutions containing salt water, such as combusting salt water or solutions containing salt water, generating steam from salt water, producing and collecting hydrogen from salt water or solutions containing salt water, and desalinating seawater;

FIGS. 13-15 are top, top/side perspective, and side views of an exemplary RF coupling circuit for exemplary RF systems for RF processing of salt water and/or solutions containing salt water, such as combusting salt water or solutions containing salt water, generating steam from salt water, producing and collecting hydrogen from salt water or solutions containing salt water, and desalinating seawater;

FIG. 17 is a medium-level flowchart of an exemplary embodiment of an RF methodology for producing and collecting hydrogen gas from salt water and solutions containing salt water;

FIGS. 18(a) and 18(b) are medium level flow charts of exemplary embodiments of an RF methodology for producing and combusting hydrogen gas from salt water and for producing and combusting hydrogen gas and producing and combusting other volatiles from solutions containing salt water;

FIGS. 19(a) and 19(b) are medium level flow charts of exemplary embodiments of an RF methodology for producing and combusting hydrogen gas from salt water and for producing and combusting hydrogen gas and producing and combusting other volatiles from solutions containing salt water, and transferring the chemical energy generated by the combustion of the hydrogen gas and other volatiles into mechanical energy capable of moving a piston;

FIG. 20 is a medium level flow chart of an exemplary embodiment of an RF methodology for desalinating seawater;

FIG. 21 is a medium level flow chart of an exemplary embodiment of an RF methodology for carrying out the electrolysis of water;

FIG. 22 is a schematic illustration showing exemplary transmission and reception enclosures with their top walls removed;

FIG. 23 is a high-level flowchart showing an exemplary method of combusting salt water and solutions containing salt water with RF energy;

FIG. 24 is a schematic illustration showing an exemplary sealed transmission enclosure which may be suitable for lowering into the ground; and

FIGS. 25-26 are medium level flowcharts of exemplary embodiments of an RF methodology for combusting gas generated from a liquid by a transmitted RF signal.

FIGS. 27, 28, 30 and 34 are photographs showing combustion of the gas product generated by the electromagnetic dissociation of water in accordance with this invention.

FIGS. 29, 31, 32 and 35 are spectra of selected samples subjected to RF irradiation according to this invention.

FIG. 33 is a photograph showing that a salt water droplet self ignites when dropped into an RF field according to the technology of this invention.

### SUMMARY

Systems are presented for using RF energy to combust salt water and/or various solutions containing salt water, to produce hydrogen from salt water, to produce volatiles from solutions containing salt water, to desalinate seawater, and/or to carry out the electrolysis of water. An exemplary system may comprise a reservoir for containing salt water that is a mixture comprising water and salt, the salt water having an effective amount of salt dissolved in the water; a reaction chamber having an inlet and an outlet; a feed line operatively connecting the reservoir to the inlet of the reaction chamber; an RF transmitter having an RF generator in circuit communication with a transmission head, the RF generator capable of generating an RF signal at least partially absorbable by the salt water having at least one frequency for transmission via the transmission head; and an RF receiver; wherein the reaction chamber is positioned such that at least a portion of the reaction chamber is between the RF transmission head and the RF receiver. Other exemplary systems may comprise a reservoir for containing a solution that is a mixture of water and salt and optionally containing (i) at least one additive, or (ii) at least one secondary fuel, or (iii) mixtures thereof.

Similarly, methods are presented for using RF energy to combust salt water and solutions containing salt water, to desalinate seawater, to produce hydrogen from salt water and solutions containing salt water, and/or to carry out the electrolysis of salt water. An exemplary method may comprise providing salt water comprising a mixture of water and at least one salt; or a salt water solution comprising a mixture of water and at least one salt and optionally containing (i) at least one additive, or (ii) at least one secondary fuel, or (iii) mixtures thereof; the salt water or salt water solution having an effective amount of the salt dissolved in the water; providing an RF transmitter having an RF generator in circuit communication with a transmission head, the RF generator capable of generating an RF signal at least partially absorbable by the salt water or salt water component of the solution containing salt water and having at least one frequency for transmission via the transmission head; arranging the transmission head near the salt water or solution containing salt water such that the RF signal transmitted via the transmission head interacts with at least some of the salt water; and transmitting the RF signal via the transmission head for a time sufficient to combust the salt water or to heat the solution containing salt water to volatilize and to combust a secondary fuel source that may be optionally present. If hydrogen gas is created from the salt water or the solution containing salt water by the RF signal, the RF signal may also be transmitted via the transmission head sufficient to combust the hydrogen gas so produced.

### DETAILED DESCRIPTION

In the accompanying drawings which are incorporated in and constitute a part of the specification, exemplary embodiments of the invention are illustrated, which, together with a general description of the invention given above, and the detailed description given below, serve to example principles of the invention.

### General Terms

“Additive” as used herein is a chemical compound having solubility, miscibility, or compatibility with various solutions of salt water (including sea water, salt water, or solutions containing salt water and optionally containing at least one secondary fuel) that furthermore is capable of altering the responsiveness of the various solutions of salt water to stimulation by RF energy.

“Circuit communication” as used herein is used to indicate a communicative relationship between devices. Direct electrical, optical, and electromagnetic connections and indirect electrical, optical, and electromagnetic connections are examples of circuit communication. Two devices are in circuit communication if a signal from one is received by the other, regardless of whether the signal is modified by some other device. For example, two devices separated by one or more of the following—transformers, optoisolators, digital or analog buffers, analog integrators, other electronic circuitry, fiber optic transceivers, or even satellites—are in circuit communication if a signal from one reaches the other, even though the signal is modified by the intermediate device(s). As a final example, two devices not directly connected to each other (e.g. keyboard and memory), but both capable of interfacing with a third device, (e.g., a CPU), are in circuit communication.

“Combustion” as used herein indicates a process that rapidly produces heat and light (perhaps caused by a rapid chemical change and with or without “burning” or “oxidation” in the classic sense). Salt water and solutions containing salt water respond to RF energy in many of the various systems and methods taught herein with rapid heating and rapid generation of light, which may be visible, UV, IR, etc. This is considered “combustion” herein, even though it may or may not be “burning” in the classic sense. “Combustion” herein also is used to indicate more typical incendiary “combustion,” i.e., the process of burning in which a rapid chemical change occurs that produces heat and light, which includes burning in the classical sense of the products produced from salt water reacting with RF. For example, when hydrogen is combusted or burned in air the hydrogen is chemically oxidized into water and undergoes such a rapid reaction that a flame is produced and the water is discharged in the form of steam.

“Desalinate” as used herein is used to indicate the process of removing salt and other chemicals from water. For example, when desalination of seawater is carried out through heating, e.g., boiling, steam is produced and collected. When the collected steam is subsequently condensed back into a liquid, pure water is obtained free of any salt or minerals. “Electrolysis” as used herein is used to indicate the process of applying energy to water in order to decompose the water into its constituent elements hydrogen and oxygen. Energy can be applied in the form of either electrical energy, as for example in the application of an electric current, or in the form of heat energy.

“Operatively connected” or “operatively connecting” as used herein is used to indicate that a functional connection (e.g., a mechanical or physical connection or an electrical or optical or electromagnetic or magnetic connection) exists between the components of a system.

“Salt water” as used herein is used to indicate a mixture comprising water and salt, the salt water having an effective amount of salt dissolved in the water. “Solution containing salt water” and “salt water solutions” are used interchangeably and as used herein indicate a mixture comprising salt water and optionally containing one or more of the following: (i) at least one additive, (ii) at least one secondary fuel, or (iii) mixtures of both. Hence, a solution containing salt water may comprise only salt water. “Salt water mixture” as used herein is used to indicate a mixture containing salt water that is used in conducting electrolysis with the various systems and methods taught herein.

“Secondary fuel” as used herein is used to indicate combustible organic compounds that can be made volatile and that have solubility, miscibility, or compatibility with various salt water solutions (including salt water, sea water, or salt water solutions containing salt water and optionally containing at least one additive). As used herein, a secondary fuel may be the only substance that is combusting; thus, use of the term secondary fuel does not necessary require that there is a primary fuel also combusting. Salt and salt solutions may be used to increase the combustion of secondary fuels without the salt or salt solution also combusting.

### Systems

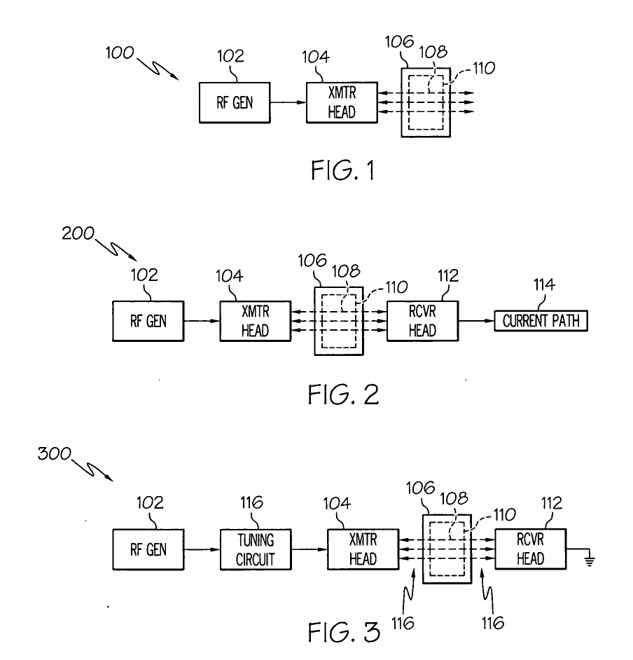

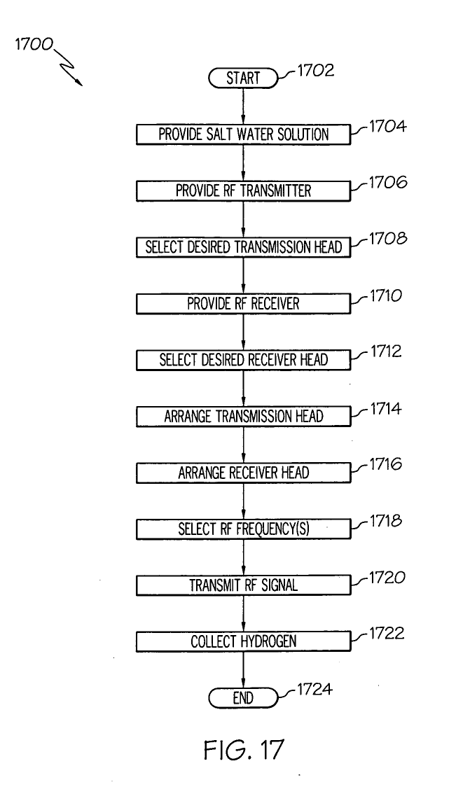

Referring to the drawings and to FIGS. 1-16A, various different views of exemplary systems and system components are shown. It is believed that these systems and components may be used with virtually all the various RF absorption enhancers and virtually all the various methods discussed herein.

The exemplary systems of FIGS. 1-4 include an RF generator 102 in circuit communication with a transmission head 104 for transmitting through a reaction chamber 106 an RF signal 108 generated by the RF generator 102 and transmitted by the transmitter head 104. The reaction chamber 106 may be open or closed, depending on the specific application. The reaction chamber may be, for example, a vessel or a cylinder with an associated piston.

### FIG. 1

Referring to FIG. 1, there is shown a first exemplary embodiment of an RF system 100 that uses an RF signal 108 to process solutions containing salt water 110 in the reaction chamber 106. For example, the RF signal 108 may combust the solution containing salt water 110. As another example, the RF signal 108 may heat the solution containing salt water 110 for further processing, e.g., steam collection and condensing to desalinate a solution containing salt water 110. As yet another example, the RF signal 108 may produce hydrogen from the solution containing salt water 110 or the RF signal may heat the solution containing salt water and volatilize any secondary fuel that may be optionally contained in the solution. The hydrogen produced as well as any volatilized secondary fuel optionally present may be collected as a gas and stored for various uses, e.g., stored for use as a fuel. Alternative, the hydrogen or any volatilized secondary fuel or both may be combusted in the reaction chamber 106. Exemplary system 100 comprises an RF generator 102 in circuit communication with a transmission head 104. A reaction chamber 106 is positioned such that at least a portion of the reaction chamber 106 is RF coupled to the transmission head 104. In exemplary system 100, the RF generator 102 communicates an RF signal for transmission to the transmission head 104. The RF signal 108 transmitted by the transmission head 104 passes through at least a portion of the reaction chamber 106. A solution containing salt water (and also a solution optionally containing (i) at least one additive, (ii) at least one secondary fuel, or (iii) mixtures thereof) 110 contained within the reaction chamber 106 is positioned such that the solution containing salt water 110 (and in particular the salt water component of the solution) absorbs at least some of the RF signal 108. Optionally, the RF generator 102 may be controlled adjusting the frequency and/or power and/or envelope, etc. of the generated RF signal and/or may have a mode in which an RF signal at a predetermined frequency and power are transmitted via transmission head 104. In addition, optionally, the RF generator 102 provides an RF signal 108 with variable amplitudes, pulsed amplitudes, multiple frequencies, etc.

The solution containing salt water 110 absorbs energy as the RF signal 108 travels through the reaction chamber 106. The more energy that is absorbed by the salt water component of the solution containing salt water 110 the higher the temperature increase in the area which leads to water decomposition and hydrogen production, and in instances where the solution containing salt water 110 also contains a secondary fuel, this may also lead to volatization and to combustion of the secondary fuel instead of or in addition to decomposition of the salt water and hydrogen production. As even more energy is absorbed by the salt water component of the solution containing salt water 110, combustion of the hydrogen that is being produced eventually occurs. The rate of energy absorption by the solution containing salt water 110 can be increased by increasing the RF signal 108 strength, which increases the amount of energy traveling through the reaction chamber 106. Other means of increasing the rate of energy absorption may include but are not limited to concentrating the signal on a localized area of the solution containing salt water 110, or further mixing with the solution containing salt water at least one additive that is appropriately selected from various chemical species to be capable of altering the rate of energy absorption of the solution containing salt water 110 and as a result may be able to increase the rate of energy absorption by the solution containing salt water 110. Examples of additives that it is believed may be useful in this regard include surfactants, chemical species that form azeotropic mixtures with water, and chemical species that alter the freezing point of water.

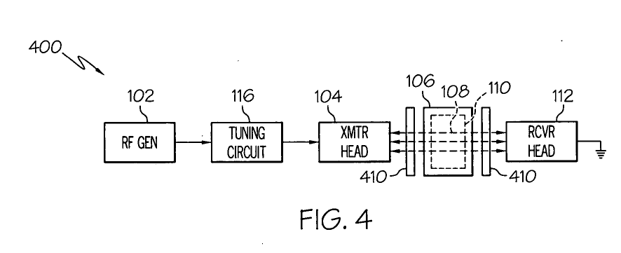

### FIGS. 2-4

As shown in FIGS. 2-4, exemplary systems may also include a receiver head 112 and an associated current path 114 to permit the RF signal 108 to be coupled through the reaction chamber 106. The systems 200, 300, 400 also use an RF signal 108 to process solutions 110 in the reaction chamber 106. For example, the RF signal 108 may combust the solution containing salt water 110. As another example, the RF signal 108 may heat the salt water component of the solution containing salt water 110 in preparation for further processing (e.g.: in instances where the solution containing salt water 110 is salt water alone, steam collection and condensing to desalinate the salt water; in instances where the solution containing salt water contains a secondary fuel, the volatization of the secondary fuel). As yet another example, the RF signal 108 may produce hydrogen from or may volatilize a secondary fuel contained within the solution containing salt water 110 and the hydrogen or the volatilized secondary fuel or both may be collected as a gas and stored for various uses, e.g., stored for use as a fuel. In the alternative, the hydrogen produced or the volatilized secondary fuel or both may be combusted in the reaction chamber 106.

Referring to FIG. 2, the exemplary system 200 has a transmission head 104 and receiver head 112 arranged proximate to and on either side at least a portion of the reaction chamber 106. This allows at least a portion of the solution containing salt water 110 in the reaction chamber 106 to be exposed to the RF signal 108 transmitted by the transmission head 104. Some portion of the RF system may be tuned so that the receiver head 112 receives at least a portion of the RF signal 108 transmitted via the transmission head 104. As a result, the receiver head 112 receives the RF signal 108 that is transmitted via the transmission head 104.

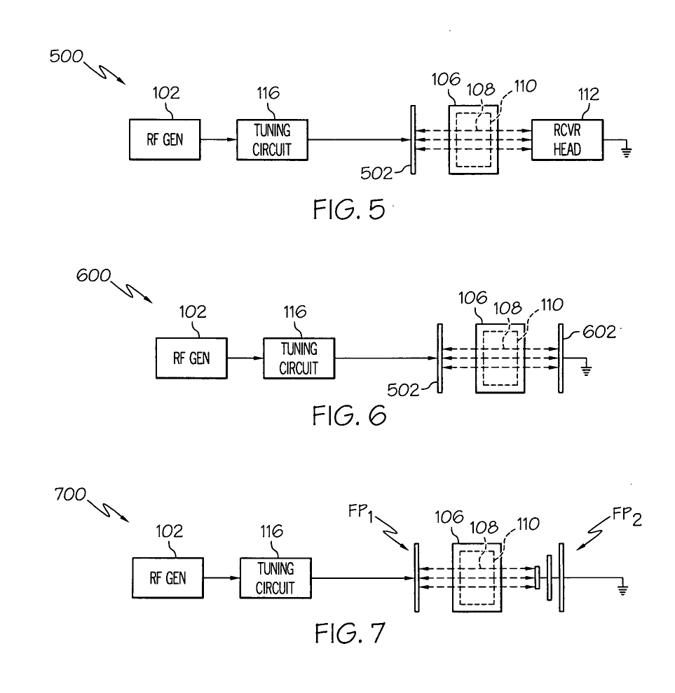

The heads 104, 112 may each or both have associated tuning circuitry such as pi-networks or tunable pi-networks, to increase throughput and generate a voltage in the area of the reaction chamber 106 and in the solution containing salt water salt 110 contained within. Thus, as shown in FIG. 3, the transmission head 104 may have an associated tuning circuit 116 in circuit communication between the RF generator 102 and the transmission head 104. Additionally, or in the alternative, as shown in FIG. 3, the current path 114 may comprise the receiver head 112 being grounded.

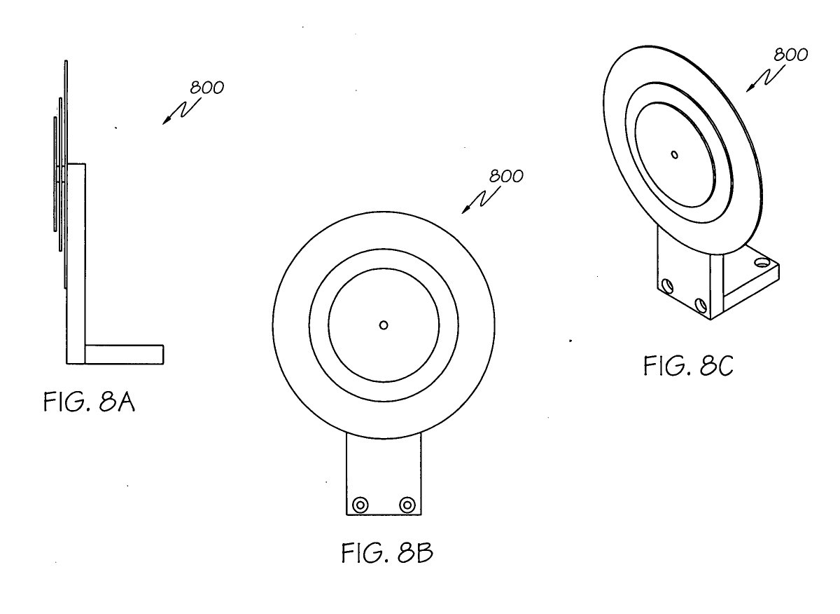

Referring to FIG. 3, the transmission head 104 and receiver head 112 may be insulated from direct contact with the reaction chamber 106. The transmission head 104 and receiver head 112 may be insulated by means of an air gap 118. An optional means of insulating the transmission head 104 and receiver head 112 from the reaction chamber 106 is shown in FIG. 4. The exemplary system 400 includes inserting an insulating layer or material 410 such as, for example, Teflon® between the heads 104, 112 and the reaction chamber 106. Other optional means include providing an insulation area on the heads 104, 112, and allowing the heads to be put in direct contact with the reaction chamber 106. The transmission head 104 and the receiver head 112, described in more detail below, may include one or more plates of electrically conductive material.

One optional method of inducing a higher temperature in the solution containing salt water 110 includes using a receiver head 112 that is larger than the transmission head 104 (although it was earlier believed that a smaller head would concentrate the RF to enhance RF heating, a larger reception head was found to generate a higher temperature, perhaps because of the use of a high-Q resonant circuit described in more detail below). For example, a single 6″ circular copper plate may be used on the Tx side and a single square 9.5″ copper plate may be used on the Rx side. Optionally, an RF absorption enhancer may be added to the solution containing salt water 110. An RF absorption enhancer is any means or method of increasing the tendency of the solution containing salt water 110 to absorb more energy from the RF signal that the salt water component of the solution containing salt water would otherwise absorb. Suitable RF absorption enhancers include, for example, suspended particles of electrically conductive material, such as metals, e.g., iron, various combination of metals, e.g., iron and other metals, or magnetic particles. The many types of RF absorption enhancers are discussed in greater detail below.

The RF generator 102 may be any suitable RF signal generator, generating an RF signal at any one or more of the RF frequencies or frequency ranges discussed herein. The RF signal 108 generated by the RF generator 102 and transmitted by the transmission head 104 may have a fundamental frequency in the HF range or the VHF range or an RF signal at some other fundamental frequency. The RF signal 108 may be a signal having one or more fundamental frequencies in the range(s) of 1-2 MHz, and/or 2-3 MHz, and/or 3-4 MHz, and/or 4-5 MHz, and/or 5-6 MHz, and/or 6-7 MHz, and/or 7-8 MHz, and/or 8-9 MHz, and/or 9-10 MHz, and/or 10-11 MHz, and/or 11-12 MHz, or 12-13 MHz, or 13-14 MHz, or 14-15 MHz. The RF signal 108 may have a fundamental frequency at 13.56 MHz. The RF generator 102 may be an ENI Model No. OEM-12B (Part No. OEM-12B-07) RF generator, which is marked with U.S. Pat. No. 5,323,329 and is known to be used to generate a 13.56 MHz RF signal for etching systems. Among other things, the ENI OEM-12B RF generator has an RF power on/off switch to switch a high-power (0-1250 Watt) RF signal, has an RF power output adjust to adjust the power of the signal generated, and has an RF power meter to measure the power of the RF signal being generated that can be switched to select either forward or reverse power metering. The power meter in reverse mode can be used to calibrate a tuning circuit, as explained above, by adjusting any variable components of the tuning circuit until minimum power is reflected back to the power meter (minimum VSWR). The ENI OEM-12B RF generator may be cooled by a Thermo Neslab Merlin Series M33 recirculating process chiller. A at 13.56 MHz RF signal from the ENI OEM-12B RF generator having a power of about 800-1000 Watts will combust salt water. In the alternative, the RF generator may be a commercial transmitter, e.g., the transmitter portion of a YAESU brand FT-1000MP Mark-V transceiver. An RF signal can be generated at about 13.56 MHz (one of the FCC-authorized frequencies for ISM equipment) by the transmitter portion of a YAESU brand FT-1000MP Mark-V transceiver by clipping certain blocking components as known to those skilled in the art. The RF generator and transmission head may have associated antenna tuner circuitry (not shown) in circuit communication therewith or integral therewith, e.g., automatic or manual antenna tuner circuitry, to adjust to the impedance of transmission head and the reaction chamber (and a receiver, if any). The transmitter portion of a YAESU brand FT-1000MP Mark-V transceiver has such integral antenna tuner circuitry (pressing a “Tune” button causes the unit to automatically adjust to the load presented to the RF generator portion). The RF generator and transmission head may have associated antenna tuner circuitry (not shown) in circuit communication therewith or integral therewith, e.g., automatic or manual antenna tuner circuitry, to adjust to the combined impedance of the reaction chamber and the receiver and compensate for changes therein. The transmitter portion of a YAESU brand FT-1000MP Mark-V transceiver has such integral antenna tuner circuitry. Various configurations for the transmission head and reception head are possible, as exemplified herein.

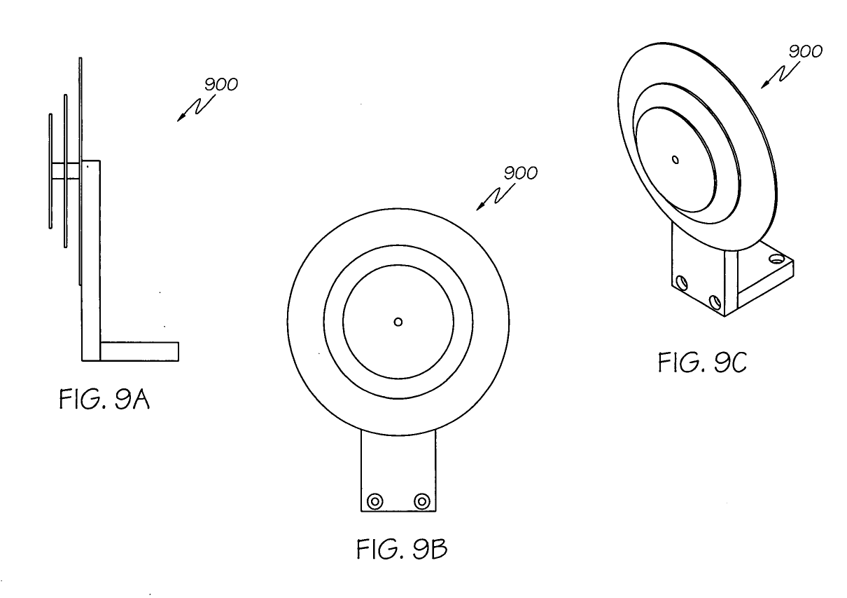

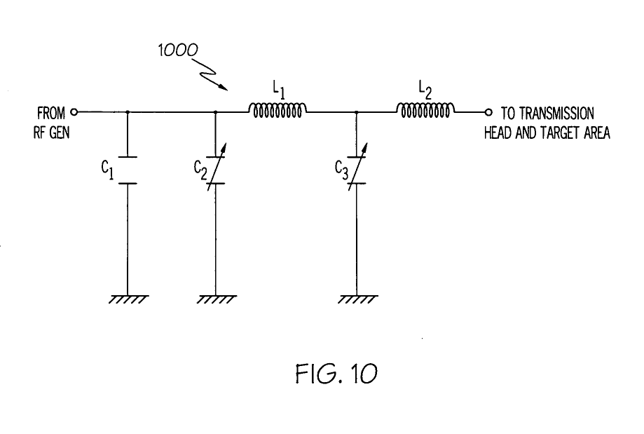

### FIGS. 5-6

The transmission head 104 may be any of a number of different transmitter head configurations, such as an electrically conductive plate having a coaxial coil in circuit communication therewith. In the alternative, as exemplified by FIG. 5, the transmission head 104 may comprise (or consist of) an electrically conductive plate 502 (e.g., a 6″ diameter, flat, planar plate made of 0.020″ stainless steel) without a corresponding coil. The transmission plate 502 may be circular and may be sized depending on the size of the target area and the desired voltage field generated by the plate. Similarly, as exemplified by FIG. 6, the receiver head 112 may comprise (or consist of) an electrically conductive plate 602 (e.g., a 6″ diameter, flat, planar plate made of 0.020″ stainless steel) without a corresponding coil. The reception plate 602 may be circular and may be sized depending on the size of the target area and the desired voltage field generated by the plate. The reception plate 602 may be sized substantially smaller or substantially larger than the transmission plate 502 to change the field generated in the reaction chamber 106 by the coupled RF signal 108. In the alternative, either the reception plate 602 or the transmission plate 502 (which includes both of them) may be parabolic plates with their convex side facing the target area (not shown). The plates may be made of copper (e.g., 0.090″ copper plate) instead of stainless steel.

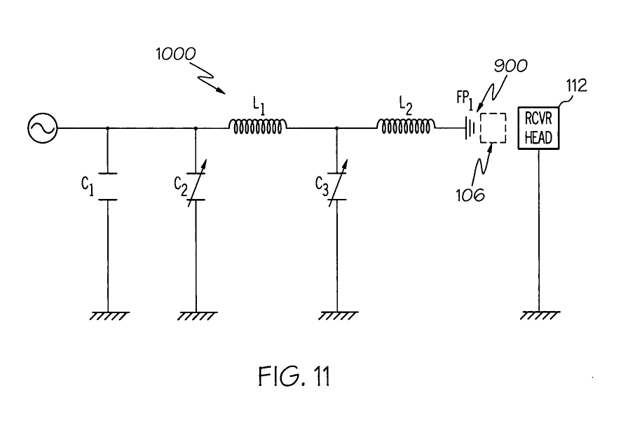

### FIG. 7-9

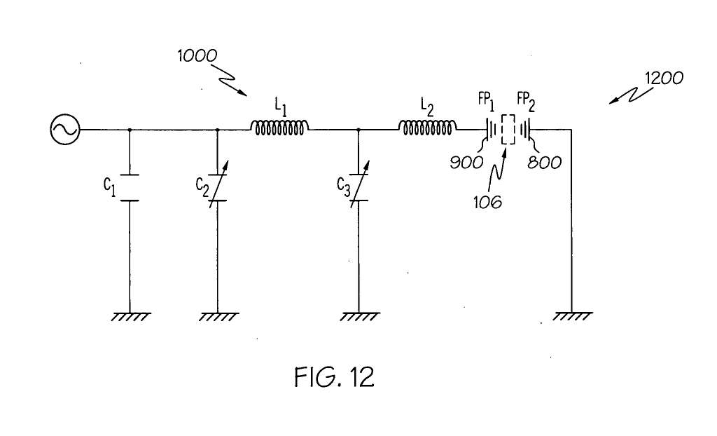

In the alternative, the transmission head 104 or receiver head 112 may each or both be comprised of a series of spaced, stacked electrically conductive plates. The spaced, stacked electrically conductive plates may be coaxial, circular plates and may have sequentially decreasing diameters. FIG. 7 shows an exemplary system 700 wherein the receiver head 112 comprising spaced, stacked, electrically conductive, coaxial, and circular plates that have sequentially decreasing diameters. The plates of exemplary receiver head 800 may be constructed as described in FIGS. 8A-8C (e.g., sized as shown with an Aluminum base) and may be insulated from each other as described in FIGS. 8A-8C. The plates may be made of copper (e.g., 0.090″ copper plate) instead of stainless steel.

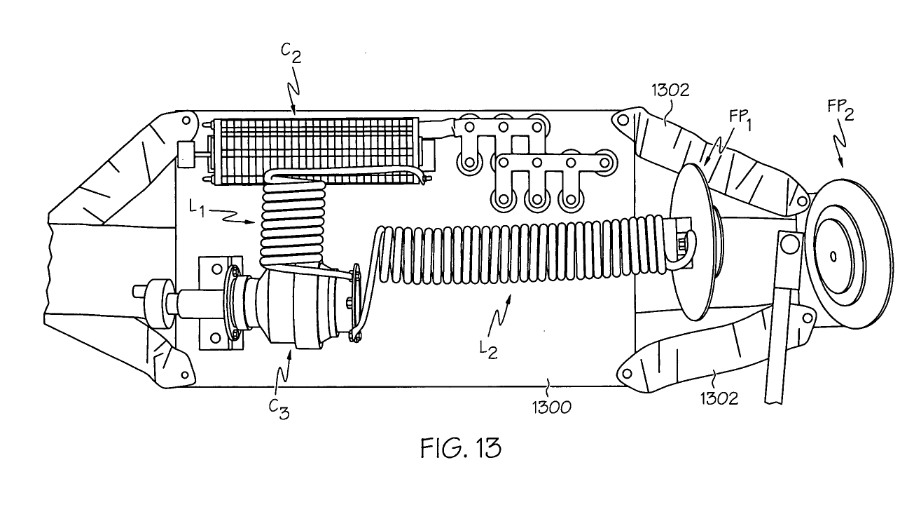

Similarly, the transmission head 104 may comprise a series of spaced, stacked electrically conductive plates. The spaced, stacked electrically conductive plates may be coaxial, circular plates and may have sequentially decreasing diameters. FIGS. 9A-9C show an exemplary transmission head 900 comprising spaced, stacked, electrically conductive, coaxial, and circular plates that have sequentially decreasing diameters. The plates of exemplary transmission head 900 may be constructed as described in FIGS. 9A-9C (e.g., sized as shown with a Teflon base) and may be insulated from each other as described in FIGS. 9A-9C. In the alternative, plates of exemplary receiver head 800 and/or the plates of exemplary transmission head 900 may be in circuit communication with each other, e.g., directly electrically coupled in their spaced configuration with electrically conductive fasteners. The plates may be made of copper (e.g., 0.090″ copper plate) instead of stainless steel. A transmission head 900 with electrically insulated plates may be used with a receiver head 800 with electrically connected plates, and vice versa.

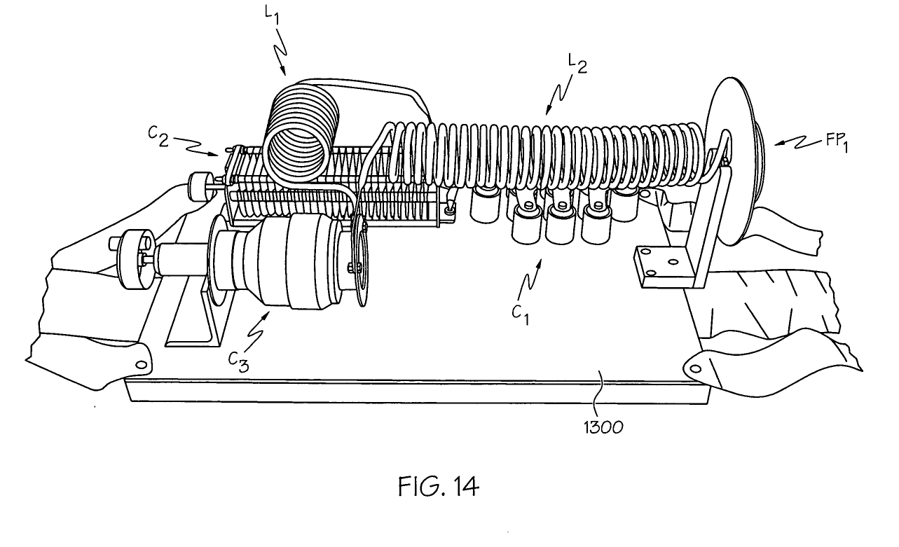

### FIGS. 10-16

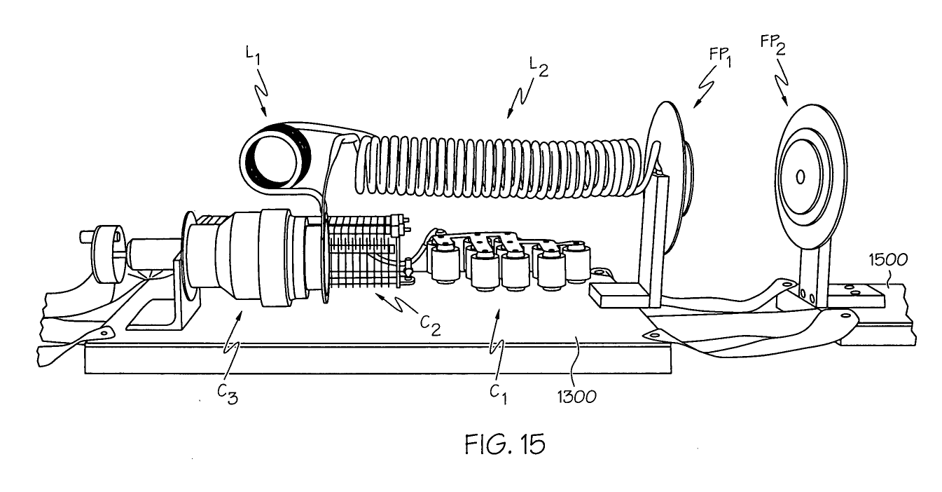

The tuning circuit 116 may be in circuit communication between the RF generator 102 and the transmission head 104 and may comprise and pi-network or a tunable pi-network. An exemplary tuning circuit 1000 is shown in FIG. 10 formed with components listed in that figure. Exemplary component values for FIGS. 10-16a are shown in Table A. Tuning circuit 1000 may be connected between an RF generator 102 and a transmission head 104. Thus, as shown in FIG. 11 an exemplary system may include an ENI OEM-12B RF generator in circuit communication with exemplary tuning circuit 1000, which is in circuit communication with exemplary transmission head 900 to generate an RF signal 108 through the reaction chamber 106 by coupling the RF signal 108 to a receiver head 112. The receiver head 112 may be the same as exemplary receiver head 800, as shown in the exemplary system of FIG. 11.

The exemplary implementation of the exemplary tuning circuit 1000 used in FIGS. 10-15 appears to show a voltage gain of about 15-to-1 with respect to the voltage of the RF signal generated by the ENI RF generator. Thus exemplary tuning circuit 1000 may be considered to be a voltage step up transformer. Voltages of the larger plate of the transmission head have been estimated to be in excess of 40,000 volts per inch. Accordingly, some or all of the transmission head and/or the receiving head may be sealed, enclosed in an enclosure, or otherwise encapsulated in an insulating material.

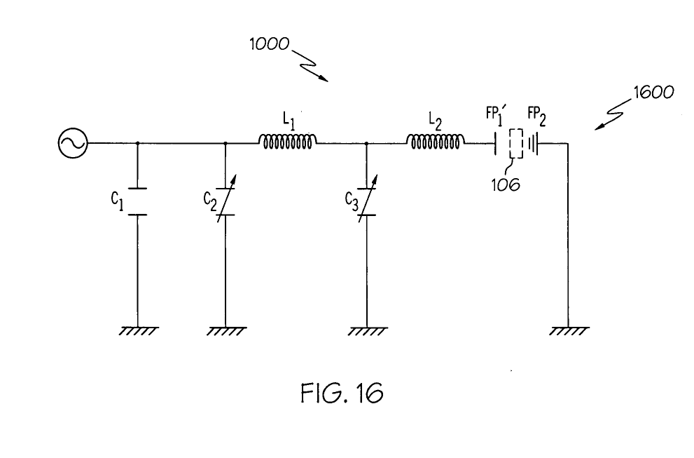

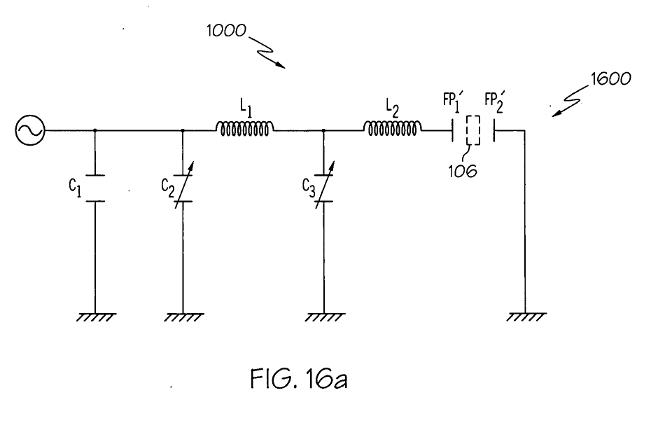

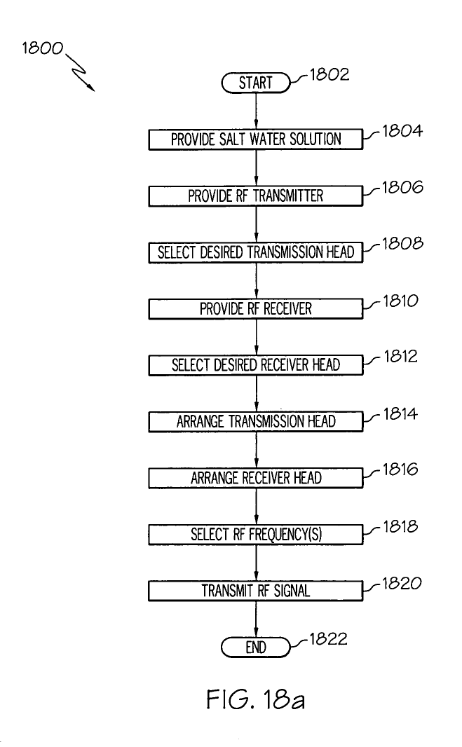

FIGS. 13-15 show different views of an exemplary implementation of portions of the exemplary system of FIG. 12. As shown in those figures, in implementing the exemplary tuning circuit 1000 used in FIGS. 10-12, the larger inductor L₂ may be positioned with its longitudinal axis substantially coaxial with the central axis of plates of transmission head FP₁, and the central axis of the small inductor L₁ may be substantially perpendicular to the longitudinal axis of the larger inductor L₂. Other components may be used to implement tuning circuit 1000 instead of the exemplary components listed on FIGS. 10-12. For example, the smaller inductor L₁ may be silver-coated or may be made of 12 turns of 5/16″ copper tubing (or more turns of larger diameter copper tubing) for increased current carrying capacity (smaller inductor L₁ can get relatively hot in exemplary embodiments), and the capacitor C₁ may be made from thirteen (13) 100 pF capacitors instead of eleven (11) for a 1300 pF capacitor C₁. As another example, the plates in the heads may be made of copper (e.g., made from 0.090″ copper plate) instead of stainless steel. In the exemplary implementation shown in FIGS. 13-15, a region of the target area slightly closer to the transmission head (about 60/40 distance ratio) heats slightly more than dead center between the two heads. The grounded portion of the components of FIGS. 10-15 may be mounted to a copper sheet 1300 or other suitable conducting sheet, and the conducting stand of reception head FP₂ may be mounted on a copper sheet 1500 or other suitable conducting sheet, as shown in FIG. 15. The grounded plates 1300, 1500 may be connected by one or more copper straps 1302.

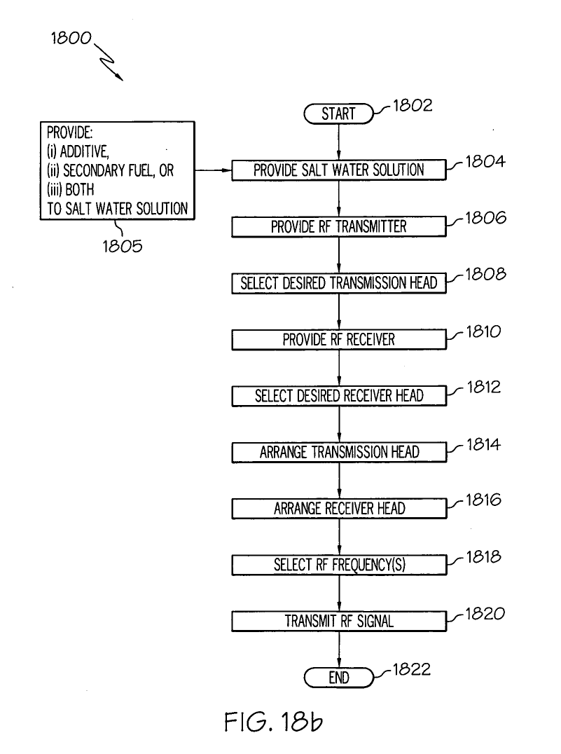

### FIG. 16

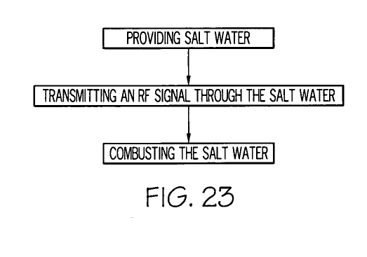

FIG. 16 shows another exemplary system 1600 that is the same as system 1200 (shown in FIGS. 8A-8C, 9A-9C, 12-15 and as described above), except the transmission head FP₁′ has a single 6″ plate, the one 6″ circular plate of transmission head FP₁, and the three 6″ and 4″ and 3″ plates of receiver head FP₂ are made from 0.090″ thick copper, capacitor C₁ is 1300 pF instead of 1100 pF, and the smaller inductor L₁ is silver-coated and made of 12 turns of 5/16″ copper tubing. FIG. 16a shows another exemplary system 1600 that is the same as system 1600 except that the receiver head FP₂′ has a single 6″ circular plate. The transmitting portion and the receiving portion may be enclosed in one or more suitable enclosures, e.g., enclosures 3502, 3504 in FIG. 22. Open circuit voltage readings at the transmission head of exemplary physical embodiments have taken. Open circuit voltages of the RF field at 100 W of transmitted power have been measured with a broadband oscilloscope at about 6000 volts (e.g., about 5800 V) peak-to-peak amplitude, which rises to about 22,000 volts at 1000 W of transmitted power (FIG. 16A in the configuration of FIGS. 13-15). Additionally, it is believed that in these exemplary systems the voltage and current are not in phase (e.g., out of phase by a certain phase angle). Additionally, perhaps improved RF heating efficiency and/or RF transmission efficiency may be realized by changing the phase relationship between the voltage and current to a predetermined phase angle or real-time determined (or optimal) phase angle. In addition, the Q of exemplary physical embodiments have been estimated using bandwidth (S9 or 3 dB point) in excess of 250 (e.g., 250-290) (FIG. 16A in the configuration of FIGS. 13-15). As should be apparent, the RF heating using these exemplary embodiments is significantly different than inductive heating (even substantially different from inductive heating at similar frequencies).

As shown in FIG. 22, the circuits may be mounted in two enclosures: a transmission enclosure 3502 and a reception enclosure 3504, with a reaction chamber 3506 there between. Exemplary transmission enclosure 3502 has grounded metallic walls 3512 on all sides except the side 3513 facing the reception enclosure 3504 (only four such grounded walls 3512a-3512d of five such walls 3512 of exemplary transmission enclosure 3502 are shown; the top grounded wall has been removed). Similarly, exemplary reception enclosure 3504 has grounded metallic walls 3514 on all sides except the side 3515 facing the transmission enclosure 3502 (only four such grounded walls 3514a-3514d of five such walls 3514 of exemplary reception enclosure 3504 are shown; the top grounded wall has been removed). The grounded walls 3512 of transmission enclosure 3502 are in circuit communication with the grounded walls 3514 of reception enclosure 3504. Facing walls 3513 and 3515 may be made from TEFLON or another suitable electrical insulator. Transmission enclosure 3502 and/or reception enclosure 3504 may be movably mounted to permit variable spacing between the transmission head and the reception head to accommodate create differently-sized reaction chambers 3506. Facing walls 3513 and 3515 may have associated openings (not shown) to which various racks and other structures can be connected to support a body part or other target structure between the transmission head and the reception head. Dispersive pads (not shown) may be provided for direct grounding of the target or capacitive grounding of the target structure, which grounding pads may be connected to the grounded walls 3512, 3514 (such direct or capacitive grounding pads may be help smaller target structures absorb relatively higher levels of RF and heat better). The transmission side components 3522 may be mounted inside exemplary transmission enclosure 3502 and the reception side components 3524 may be mounted inside exemplary reception enclosure 3504. Exemplary transmission enclosure 3502 and reception enclosure 3504 both may be cooled with temperature-sensing fans that turn on responsive to the heat inside the enclosures 3502, 3504 reaching a predetermined thermal level. Exemplary transmission enclosure 3502 and reception enclosure 3504 also have a plurality of pass-through connectors, e.g., permitting the RF signal to pass from the RF signal generator into the exemplary transmission enclosure 3502 (perhaps via a power meter) and permitting the received signal to pass outside exemplary reception enclosure 3504 to a power meter and back inside reception enclosure 3504. In this exemplary embodiment, the enclosures 3502, 3504 may be moved to vary the spacing between the distal, adjacent ends of the heads from about two inches to a foot or more apart. Various other embodiments may have different ranges of spacing between the distal, adjacent ends of the heads, e.g., from about 2″ to about 20″ or more apart or from about 2″ to about 40″ or more apart.

Each such enclosure may have grounded (e.g., aluminum) walls with a grounded (e.g., copper) base plate, except for the walls proximate the transmission head FP₁′ and the reception head FP₂., which may be made from an electrical insulator such as ceramic or TEFLON brand PTFE, e.g., TEFLON brand virgin grade electrical grade PTFE, or another insulator. The walls may be grounded to the copper plate using copper straps and, if a plurality of enclosures are used, the enclosures may have copper strap between then to ground the enclosures together. A long standard fluorescent light bulb can be used to confirm effective grounding (e.g., by turning on the RF signal and repeatedly placing the light bulb proximate the transmission head to illuminate the bulb and then moving the bulb to locations around the enclosure watching for the light bulb to cease illumination, which confirms acceptable grounding). The grounded walls may have a layer of electrical insulator on the inside thereof, such as ceramic or TEFLON brand PTFE, e.g., TEFLON brand virgin grade electrical grade PTFE, or another insulator.

The exemplary systems of FIGS. 12-16 are believed to generate a very high voltage field in the target area, which very high voltage field can be used to heat many different types of RF absorbing particles as part of RF absorption enhancers in connection with the various methods taught herein. For example, the exemplary systems of FIGS. 12-16 are believed to be capable of heating and combusting salt water solutions in connection with the various methods taught herein.

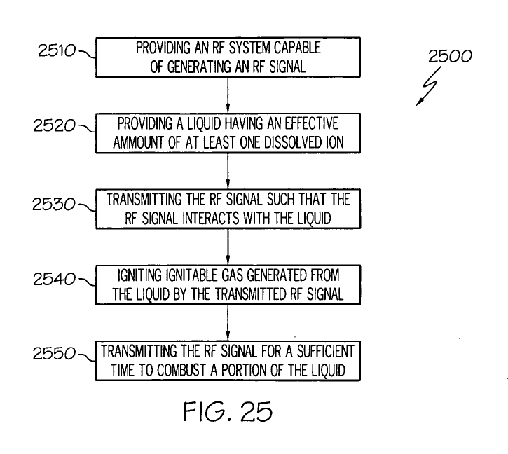

FIG. 24 illustrates an exemplary transmission arrangement 2400 that is adapted for at least partial submersion in a liquid. The enclosure includes a sealed circuit housing 2405 in which is enclosed a tuning circuit 2420 and a transmission head 2425. The tuning circuit receives an RF signal from an RF generator 2410 that may be enclosed in the enclosure as shown or located outside of the enclosure 2405. An insulated region 2430, e.g., an air pocket or pocket of another gas, is disposed between the transmission head 2425 and the enclosure 2405. The enclosure may also include a mounting means, such as a hook or loop 2450, that is used to mechanically couple the enclosure to a cable or other similar mechanism for lowering the enclosure into a hole or confined treatment area, e.g., with a winch or crane (not shown) or other means for mowering. If the RF generator 2410 is located outside the sealed enclosure 2405, an insulated electrical conductor (not shown) may be provided to place the circuit 2420 in circuit communication with the RF generator. During construction, air from the portion of the enclosure 2405 surrounding the coupling circuit may be evacuated and the enclosure 2405 filled with an inert gas, such as nitrogen or xenon and then sealed. The coupling circuit may be tunable or not (e.g., pre-tuned), and may be the same as any of the coupling circuits shown or described herein, with virtually any of the transmission heads shown herein. If the coupling circuit portion of the enclosure 2405 is filled with an inert gas, it is believed that much higher powered RF signals may be coupled using the various coupling circuits disclosed herein, e.g., FIGS. 13-15 or FIG. 16a. In the alternative, if the coupling circuit portion of the enclosure 2405 is filled with an inert gas, it is believed that significantly smaller coupling circuits may be used vis-á-vis the exemplary coupling circuit of FIGS. 13-15, because smaller components may be used (by increasing the voltage break down of the coupled components within the enclosure). If the coupling circuit is tunable, such tuning may be accomplished using remotely controllable tunable components, e.g., variable capacitors having stepper motors configured to change the value of the capacitor, or with remote cables to remotely mechanically change the value of the capacitor. Thus, a control unit remove from the enclosure (not shown) may be used to send electrical signals to tune the circuit to reduce or remove reflected power or a user may mechanically remotely tune the circuit to reduce or remove reflected power. Although a grounded reception head (not shown) may be used in this configuration (e.g., also mounted to the enclosure and configured to permit water to flow between the transmission and reception heads or between the insulated region and the reception head) it is believed that it may be possible to tune the circuit without a reception head per se, using the target water as a receiver and a current path (as a sort of grounded reception head).

### Methods

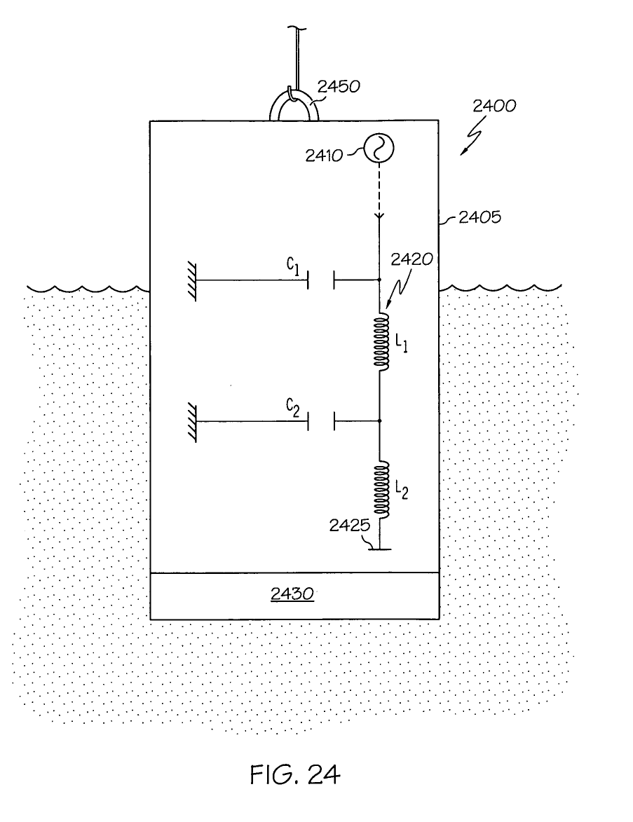

Solutions containing salt water and that optionally contain (i) at least one additive, or (ii) at least one secondary fuel, or (iii) mixtures thereof may be combusted using RF signals by passing a high-voltage RF signal through the solution containing salt water. In a general sense, the methods may be characterized by providing a solution containing salt water and that may optionally contain (i) at least one additive, or (ii) at least one secondary fuel, or (iii) mixtures thereof and passing an RF signal through the solution containing salt water to combust the solution containing salt water (FIG. 23). Alternatively, in a general sense the methods may be characterized as methods for adding salt to enhance the heating of water or other liquids. Salt water has been combusted using an exemplary system that included a circuit implementation of the circuit of FIG. 16 being used to transmit an RF signal through the salt water to combust the salt water. A solution of OCEANIC brand Natural Sea Salt Mix having a specific gravity of about 1.026 g/cm³ was used. A 13.56 MHz RF signal from an ENI OEM-12B RF generator having a power of about 800-1000 Watts (e.g., about 900 Watts) was used to combust the salt water.

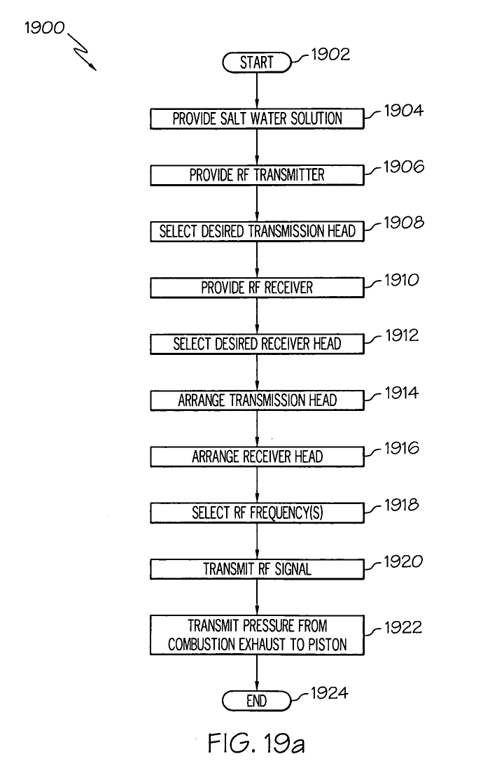

### FIG. 17

FIG. 17 illustrates a high level exemplary methodology 1700 for producing hydrogen from salt water or from solutions containing salt water.

The methodology begins at block 1702. At block 1704 the salt water is provided. The salt water comprises water and at least one salt wherein an effective amount of salt is dissolved in the water. In certain embodiments salt is added to water or other liquids to enhance heating. Optionally, a solution containing salt water may be used that contains salt water and (i) at least one additive, or (ii) at least one secondary fuel, or (iii) mixtures thereof. The salt can be any type of useful salt which is water soluble. Several examples of useful salts are described in greater detail below. An effective amount of salt is the amount of salt necessary to absorb sufficient energy output from the RF signal such that salt water or a solution containing salt water undergoes decomposition to generate hydrogen. OCEANIC brand Natural Sea Salt Mix may be used to approximate the composition of naturally occurring seawater having an effective amount of salt, and that may be used further as either salt water or as the salt water component in a solution containing salt water that is used in the systems and methods discussed and shown herein. Such approximations of naturally occurring seawater may have a specific gravity of about 1.02 g/cm³ to 1.03 g/cm³, e.g., between about 1.020-1.024 or about 28-32 PPT, as read off of a hydrometer. As an approximation of naturally occurring seawater, a mixture of water with the above-identified sea salt having a specific gravity of about 1.026 g/cm³ (as measured with a refractometer) was used in exemplary systems and methods. In the alternative, it is believed that actual seawater may be used in the systems and methods discussed and shown herein.

It is contemplated that a reservoir of salt water or a solution containing salt water could be made beforehand and stored in a tank such that it would be available upon demand. For example, the storage tank could be connected to the reaction chamber by means of a feed tube. In this manner, a supply of the previously prepared salt water or solution could be pumped from the storage tank into the reaction chamber via the feed tube; wherein the feed tube has one end connected to the storage tank and the other end connected to an inlet present on the reaction chamber. Again, it is believed that ordinary sea water may be used.

At block 1706 an RF transmitter is provided. The RF transmitter may be any type of RF transmitter generating a suitable RF signal. RF transmitter may be a variable frequency RF transmitter. Optionally, the RF transmitter is also multi-frequency transmitter capable of providing multiple-frequency RF signals. Optionally the RF transmitter is capable of transmitting RF signals with variable amplitudes or pulsed amplitudes. One or more of a variety of different shapes and sizes of transmission and reception heads may be provided.

The transmission head may be selected at block 1708. The selection of the transmission head may be based in part on the type of RF transmitter provided. Other factors, such as, for example, the depth, size and shape of the general target area, or specific target area to be treated, and the number of frequencies transmitted may also be used in determining the selection of the transmission head.

The RF receiver is provided at block 1710. The RF receiver may be tuned to the frequency(s) of the RF transmitter. At block 1712, the desired receiver head may be selected. Similarly to the selection of the transmission head, the receiver head may be selected to fit the desired characteristics of the particular application. For example, a receiver head that is larger than the transmission head can be selected to concentrate the RF signal on a specific area in the reaction chamber (although it was earlier believed that a smaller head would concentrate the RF to enhance RF heating, a larger reception head was found to generate a higher temperature). For example, a single 6″ circular copper plate may be used on the Tx side and a single square 9.5″ copper plate may be used on the Rx side. In this manner, selection of various sizes and shapes of the receiver heads allow for optimal concentration of the RF signal in the salt water mixture.

At block 1714 the transmission head is arranged. Arrangement of the transmission head is accomplished by, for example, placing the transmission head proximate to and on one side of the reaction chamber. At block 1716 the receiver head is arranged. Arrangement of the receiver head is similarly accomplished by, for example, placing the receiver head proximate to and on the other side of the reaction chamber so that an RF signal transmitted via the transmission head to the receiver head will pass through the reaction chamber and be absorbed by the salt water or the salt water component of the solution containing salt water. The transmission head and reception heads are insulated from direct contact with the reaction chamber. The heads may be insulated from the reaction chamber by means of an air gap. Optionally, the heads may be insulated from the target area by means of another insulating material.

The RF frequency(s) may be selected at block 1718. In addition to selecting the desired RF frequency(s) at block 1718, the transmission time or duration may also be selected. The duration time is set to, for example, a specified length of time, or set to raise the temperature of at least a portion of the salt water or the solution containing salt water to a desired temperature/temperature range, or set to a desired change in temperature. In addition, optionally, other modifications of the RF signal may be selected at this time, such as, for example, amplitude, pulsed amplitude, an on/off pulse rate of the RF signal, a variable RF signal where the frequency of the RF signal varies over a set time period or in relation to set temperatures, ranges or changes in temperatures.

At block 1720 the RF signal is transmitted from the transmission head to the receiver head. The RF signal passes through the reaction chamber and is absorbed by the salt water or the salt water component of the solution containing salt water that is contained within the reaction chamber. Absorption of the RF energy results in decomposition of the salt water or the salt water component of the solution containing salt water to generate hydrogen.

At block 1722 the hydrogen produced by decomposition of a salt water or solution containing salt water is collected. Hydrogen may be collected by any means. An example of a means for collecting hydrogen would be to utilize a vacuum or pump apparatus to remove the hydrogen gas as it is produced and to then retain the hydrogen in a location physically separated from the reaction chamber. For example, such a vacuum or pump apparatus could have one end attached to an outlet present on the reaction chamber and the other end attached to a gas storage container. It is contemplated that the gas storage container may be fitted with valves, as for example a one way valve, such that gas could enter or be pumped into the tank but then the gas could not leave the tank.

The methodology may end at block 1724 and may be ended after a predetermined time interval and/in response to a determination that a desired amount of hydrogen production has been achieved. The method may be performed once or repeatedly, or continuously, or periodically, or intermittently.

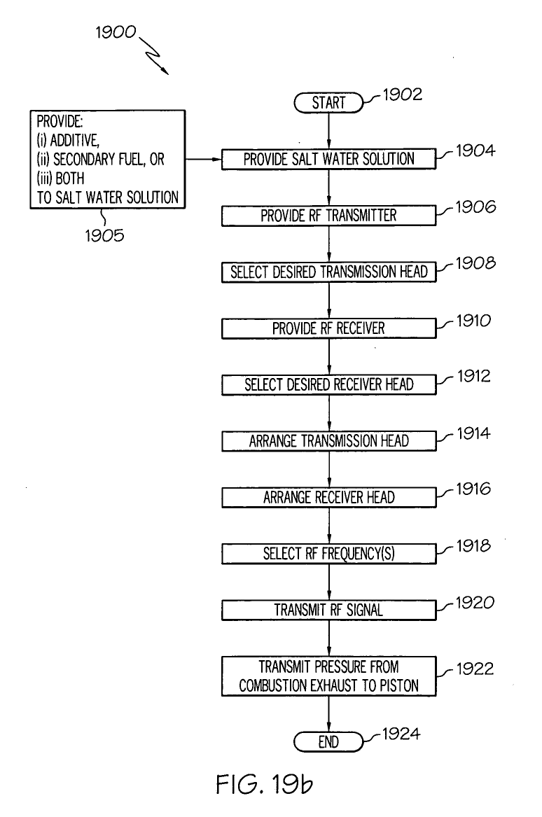

### FIGS. 18(a) and 18(b)

FIG. 18(a) illustrates a high level exemplary methodology 1800 for producing hydrogen from salt water and subsequently for the combustion of the hydrogen produced. FIG. 18(b) illustrates a high level exemplary methodology 1800 for (i) sufficiently heating a solution containing salt water that may optionally contain a secondary fuel in order to volatilize and combust the secondary fuel; or (ii) decomposing the salt water component of the solution containing salt water to generate hydrogen and to subsequently combust the hydrogen produced; or (iii) both.

The methodology for both FIGS. 18(a) and 18(b) begins at block 1802. At block 1804 either salt water or a solution containing salt water is provided. In FIG. 18(a) the salt water comprises water and at least one salt, wherein an effective amount of salt is dissolved in the water. In certain embodiments salt is added to water or other liquids to enhance heating. In FIG. 18(b) the salt water solution comprises the salt water of FIG. 18(a) and optionally: (i) at least one additive, or (ii) at least one secondary fuel source, or (iii) mixtures thereof. The salt used in FIGS. 18(a)-(b) can be any type of useful salt which is water soluble. Several examples of useful salts are described in greater detail below. An effective amount of salt is the amount of salt necessary to allow surrounding water to absorb sufficient energy output from the RF signal such that it undergoes decomposition to generate hydrogen, or the amount of salt necessary to allow surrounding water to absorb sufficient energy output from the RF signal such that it undergoes sufficient heating to volatilize and combust any secondary fuel source optionally present. OCEANIC brand Natural Sea Salt Mix may be used to approximate the composition of naturally occurring seawater having an effective amount of salt and that may be used further as the salt water component of the salt water containing solution in the systems and methods discussed and shown herein. Such approximations of naturally occurring seawater may have a specific gravity of about 1.02 g/cm³ to 1.03 g/cm³, e.g., between about 1.020-1.024 or about 28-32 PPT, as read off of a hydrometer. As an approximation of naturally occurring seawater, a mixture of water with the above-identified sea salt having a specific gravity of about 1.026 g/cm³ (as measured with a refractometer) was used in exemplary systems and methods. In the alternative, it is believed that actual seawater may be used in the systems and methods discussed and shown herein.

It is contemplated that a reservoir of salt water or a solution containing salt water could be made beforehand and stored in a tank such that it would be available upon demand. For example, the storage tank could be connected to the reaction chamber by means of a feed tube. In this manner, a supply of the salt water or the salt water containing solution previously prepared could be pumped from the storage tank into the reaction chamber via the feed tube; wherein the feed tube has one end connected to the storage tank and the other end connected to an inlet present on the reaction chamber.

At block 1806 an RF transmitter is provided. The RF transmitter may be any type of RF transmitter generating a suitable RF signal. RF transmitter may be a variable frequency RF transmitter. Optionally, the RF transmitter may also be a multi-frequency transmitter capable of providing multiple-frequency RF signals. Still yet, optionally the RF transmitter may be capable of transmitting RF signals with variable amplitudes or pulsed amplitudes. A variety of different shapes and sizes of transmission and reception heads may be provided.

The transmission head may be selected at block 1808. The selection of the transmission head may be based in part on the type of RF transmitter provided. Other factors, such as, for example, the depth, size and shape of the general target area, or specific target area to be treated, and the number of frequencies transmitted may also be used in determining the selection of the transmission head.

The RF receiver is provided at block 1810. The RF receiver may be tuned to the frequency(s) of the RF transmitter. At block 1812, the desired receiver head may be selected. Similarly to the selection of the transmission head, the receiver head may be selected to fit the desired characteristics of the particular application. For example, a receiver head that is larger than the transmission head can be selected to concentrate the RF signal on a specific area in the reaction chamber (although it was earlier believed that a smaller head would concentrate the RF to enhance RF heating, a larger reception head was found to generate a higher temperature). Various sizes and shapes of the receiver heads allow for optimal concentration of the RF signal in the salt water and solutions containing salt water.

At block 1814 the transmission head is arranged. Arrangement of the transmission head is accomplished by, for example, placing the transmission head proximate to and on one side of the reaction chamber. At block 1816 the receiver head is arranged. Arrangement of the receiver head is similarly accomplished by, for example, placing the receiver head proximate to and on the other side of the reaction chamber so that an RF signal transmitted via the transmission head to the receiver head will pass through the reaction chamber and be absorbed by the salt water or the salt water component of a solution containing salt water. The transmission head and reception heads are insulated from direct contact with the reaction chamber. The heads may be insulated from the reaction chamber by means of an air gap. Optionally, the heads may be insulated from the target area by means of another insulating material.

The RF frequency(s) may be selected at block 1818. In addition to selecting the desired RF frequency(s) at block 1818, the transmission time or duration may also be selected. The duration time is set to, for example, a specified length of time, or set to raise the temperature of at least a portion of the salt water or the solution containing salt water to a desired temperature/temperature range, or set to a desired change in temperature. In addition, optionally, other modifications of the RF signal may be selected at this time, such as, for example, amplitude, pulsed amplitude, an on/off pulse rate of the RF signal, a variable RF signal where the frequency of the RF signal varies over a set time period or in relation to set temperatures, ranges or changes in temperatures.

At block 1820 the RF signal is transmitted from the transmission head to the receiver head. The RF signal passes through the reaction chamber and is absorbed by the salt water or the salt water component of the solution containing salt water that is present within the reaction chamber. In FIG. 18(a), absorption of the RF energy initially results in decomposition of the salt water to produce hydrogen, while still further absorption of the RF energy eventually leads to the combustion of the hydrogen produced by the decomposition of the salt water. In FIG. 18(b), absorption of the RF energy initially results in (i) sufficiently heating the solution containing salt water in order to volatilize and to combust any secondary fuel that may be optionally present; or (ii) decomposition of the salt water component of the solution containing salt water to generate hydrogen; or (iii) both.

The methodology may end at block 1822 and may be ended after a predetermined time interval and/in response to a determination that a desired amount of hydrogen production and hydrogen combustion, or alternatively a desired amount of volatilization and combustion of the secondary fuel that may be optionally present is achieved. The method may be performed once or repeatedly, or continuously, or periodically, or intermittently.

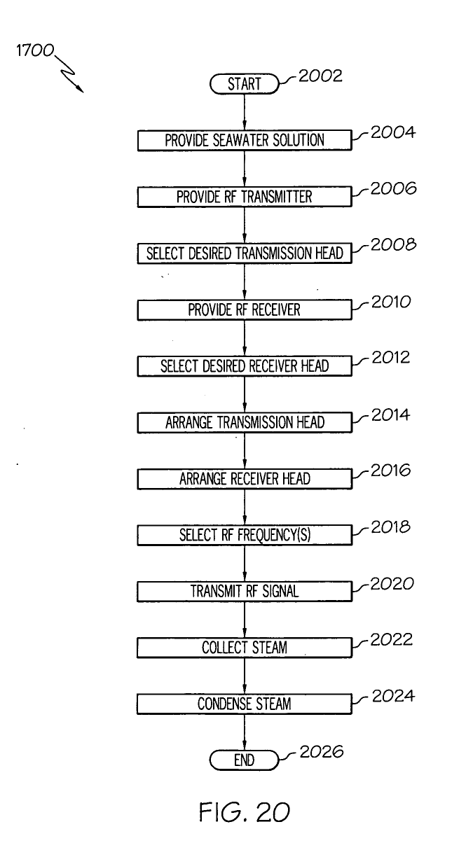

### FIGS. 19(a) and 19(b)

FIG. 19(a) illustrates a high level exemplary methodology 1900 for producing hydrogen from salt water, for the combustion of the hydrogen produced, and for the subsequent conversion of this chemical energy into mechanical energy that moves a piston. FIG. 19(b) illustrates a high level exemplary methodology 1900 for (i) sufficiently heating a solution containing salt water that may optionally contain a secondary fuel in order to volatilize and combust the secondary fuel; or (ii) decomposing the salt water component of the solution containing salt water to generate hydrogen and to subsequently combust the volatilized secondary fuel source or the hydrogen produced; or (iii) both; and for the subsequent conversion of the chemical energy that combustion releases into mechanical energy that moves a piston.

The methodology for both FIGS. 19(a) and 19(b) begins at block 1902. At block 1904 either salt water or a solution containing salt water is provided. In FIG. 19(a) the salt water comprises water and at least one salt wherein an effective amount of salt is dissolved in the water. In certain embodiments salt is added to water or other liquids to enhance heating. In FIG. 19(b) the solution containing salt water comprises the salt water from FIG. 19(a) and optionally (i) at least one additive, or (ii) at least one secondary fuel, or (iii) mixtures thereof. The salt can be any type of useful salt which is water soluble. Several examples of useful salts are described in greater detail below. An effective amount of salt is the amount of salt necessary to allow surrounding water to absorb sufficient energy output from the RF signal such that it undergoes decomposition to generate hydrogen, or the amount of salt necessary to allow surrounding water to absorb sufficient energy output from the RF signal such that it undergoes sufficient heating to volatilize and combust any secondary fuel source optionally present. OCEANIC brand Natural Sea Salt Mix may be used to approximate the composition of naturally occurring seawater having an effective amount of salt and that may be used further as the salt water component of the solutions containing salt water that are used in the systems and methods discussed and shown herein. Such approximations of naturally occurring seawater may have a specific gravity of about 1.02 g/cm³ to 1.03 g/cm³, e.g., between about 1.020-1.024 or about 28-32 PPT, as read off of a hydrometer. As an approximation of naturally occurring seawater, a mixture of water with the above-identified sea salt having a specific gravity of about 1.026 g/cm³ (as measured with a refractometer) was used in exemplary systems and methods. In the alternative, it is believed that actual seawater may be used in the systems and methods discussed and shown herein.

It is contemplated that a reservoir of the salt water or a solution containing salt water could be made beforehand and stored in a tank such that it would be available upon demand. For example, the storage tank could be connected to the reaction chamber by means of a feed tube. In this manner, a supply of the salt water or the solution containing salt water previously prepared could be pumped from the storage tank into the reaction chamber via the feed tube; wherein the feed tube has one end connected to the storage tank and the other end connected to an inlet present on the reaction chamber. Alternatively, it is contemplated that a spray nozzle could be attached onto the end of the feed tube leading into the inlet present on the reaction chamber. In this arrangement it is believed that the salt water or the solution containing salt water could be introduced into the reaction chamber in the form of a mist or spray.

At block 1906 an RF transmitter is provided. The RF transmitter may be any type of RF transmitter generating a suitable RF signal. RF transmitter may be a variable frequency RF transmitter. Optionally, the RF transmitter may also be a multi-frequency transmitter capable of providing multiple-frequency RF signals. Still yet, optionally the RF transmitter may be capable of transmitting RF signals with variable amplitudes or pulsed amplitudes. A variety of different shapes and sizes of transmission and reception heads may be provided.

The transmission head may be selected at block 1908. The selection of the transmission head may be based in part on the type of RF transmitter provided. Other factors, such as, for example, the depth, size and shape of the general target area, or specific target area to be treated, and the number of frequencies transmitted may also be used in determining the selection of the transmission head.

The RF receiver is provided at block 1910. The RF receiver may be tuned to the frequency(s) of the RF transmitter. At block 1812, the desired receiver head may be selected. Similarly to the selection of the transmission head, the receiver head is may be selected to fit the desired characteristics of the particular application. For example, a receiver head that is larger than the transmission head can be selected to concentrate the RF signal on a specific area in the reaction chamber (although it was earlier believed that a smaller head would concentrate the RF to enhance RF heating, a larger reception head was found to generate a higher temperature). Various sizes and shapes of the receiver heads allow for optimal concentration of the RF signal in the salt water and solution containing salt water.

At block 1914 the transmission head is arranged. Arrangement of the transmission head is accomplished by, for example, placing the transmission head proximate to and on one side of the reaction chamber. At block 1916 the receiver head is arranged. Arrangement of the receiver head is similarly accomplished by, for example, placing the receiver head proximate to and on the other side of the reaction chamber so that an RF signal transmitted via the transmission head to the receiver head will pass through the reaction chamber and be absorbed by the salt water or the salt water component of a solution containing salt water. The transmission head and receiving heads are insulated from direct contact with the reaction chamber. The heads may be insulated from the reaction chamber by means of an air gap. Optionally, the heads are insulated from the target area by means of another insulating material.

The RF frequency(s) may be selected at block 1918. In addition to selecting the desired RF frequency(s) at block 1918, the transmission time or duration may also be selected. The duration time is set to, for example, a specified length of time, or set to raise the temperature of at least a portion of the salt water or salt water solution to a desired temperature/temperature range, or set to a desired change in temperature. In addition, optionally, other modifications of the RF signal may be selected at this time, such as, for example, amplitude, pulsed amplitude, an on/off pulse rate of the RF signal, a variable RF signal where the frequency of the RF signal varies over a set time period or in relation to set temperatures, ranges or changes in temperatures.

At block 1920 the RF signal is transmitted from the transmission head to the receiver head. The RF signal passes through the reaction chamber and is absorbed by the salt water or the salt water component of the salt water containing solution present within the reaction chamber. In FIG. 19(a), absorption of the RF energy initially results in decomposition of the salt water to produce hydrogen, while still further absorption of the RF energy eventually leads to the combustion of the hydrogen produced by the decomposition of the salt water. In FIG. 19(b), absorption of the RF energy initially results in (i) sufficiently heating the solution containing salt water in order to volatilize and to combust any secondary fuel that may be optionally present; or (ii) decomposition of the salt water component of the aqueous solution to generate hydrogen; or (iii) both.

Alternatively, it is contemplated that an ignition source, for example a spark plug, could be attached to the reaction chamber. This ignition source would also be in circuit communication with a current source, such as for example a battery. The arrangement contemplated here would provide for a current going to the ignition source to be switched on and off when desired. This would result in generation of an ignition event, as for example with a spark plug a spark would be produced, on demand. It is believed that this ignition event would cause the combustion of the hydrogen that had been produced by the decomposition of the salt water, or would cause the combustion of either the hydrogen or any volatilized secondary fuel or both that is produced by RF treatment of a solution containing salt water in the reaction chamber.

At block 1922, the energy generated from the combustion of hydrogen, which is produced from the decomposition of the salt water (or more generally, the energy generated from either (i) combustion of the hydrogen produced from decomposition of the salt water, or (ii) the volatilization and combustion of any secondary fuel that may be optionally present in a solution containing salt water, or (iii) both), is transmitted to a piston in order to perform mechanical work. In any event, the combustion of either the hydrogen or any secondary fuel or both generates hot exhaust gases including steam. These hot exhaust gases expand and in doing so create an increase in pressure. It is contemplated that the head of a piston could be attached to the outlet present on the reaction chamber and the other end of piston attached to a lever arm. As expanding exhaust gases push against the piston head, the lever arm is moved transforming the chemical energy of expanding exhaust gases into mechanical energy and into the performance of mechanical work.

It is further contemplated that this piston arrangement could be utilized together with the spray nozzle and ignition source described above, to allow one to convert chemical energy into mechanical energy and subsequently into the performance of mechanical work, on demand. For example, this method could be used in such an arrangement in order to power an internal combustion engine. It is further contemplated that one example of how this method together with the appropriate system could be utilized, would be in providing an engine that would be fueled by salt water or various solutions containing salt water, or even directly by seawater taken from the ocean without further purification, rather than requiring gasoline or other water incompatible hydrocarbon fuels to operate. Specifically, it is contemplated that this engine could be provided in an appropriate size and in a manner such that it could be used to power an automobile or other form of motorized vehicle.

The methodology may end at block 1924 and may be ended after a predetermined time interval and/in response to a determination that a desired amount of hydrogen production and hydrogen combustion, or alternatively that a desired amount of volatilization and combustion of any secondary fuel source that is optionally present has been achieved. The method may be performed once or repeatedly, or continuously, or periodically, or intermittently.

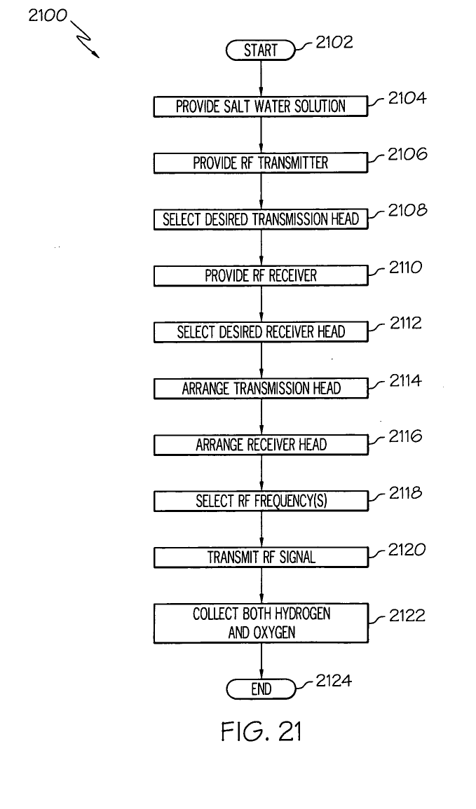

### FIG. 20

FIG. 20 illustrates a high level exemplary methodology 2000 for desalinating seawater.

The methodology begins at block 2002. At block 2004 seawater is provided. Any manner of seawater from any ocean or of any concentration or salinity would suffice. Furthermore, it is contemplated that the seawater could be taken from the source in its natural occurring form and used directly without the need for any further purification or processing. Examples of several sources for seawater are described below. It is also contemplated that an amount of seawater could be stored in a reservoir or storage tank such that it would be available to fill the reaction chamber upon demand. For example, the storage tank could be connected to the reaction chamber by means of a feed tube. In this manner, a supply of seawater could be pumped from the storage tank into the reaction chamber via the feed tube; wherein the feed tube has one end connected to the storage tank and the other end connected to an inlet present on the reaction chamber.

At block 2006 an RF transmitter is provided. The RF transmitter may be any type of RF transmitter generating a suitable RF signal. RF transmitter may be a variable frequency RF transmitter. Optionally, the RF transmitter may also be a multi-frequency transmitter capable of providing multiple-frequency RF signals. Still yet, optionally the RF transmitter may be capable of transmitting RF signals with variable amplitudes or pulsed amplitudes. A variety of different shapes and sizes of transmission and reception heads are provided.

The transmission head may be selected at block 2008. The selection of the transmission head may be based in part on the type of RF transmitter provided. Other factors, such as, for example, the depth, size and shape of the general target area, or specific target area to be treated, and the number of frequencies transmitted may also be used in determining the selection of the transmission head.

The RF receiver is provided at block 2010. The RF receiver may be tuned to the frequency(s) of the RF transmitter. At block 2012, the desired receiver head may be selected. Similarly to the selection of the transmission head, the receiver head may be selected to fit the desired characteristics of the particular application. For example, a receiver head that is larger than the transmission head can be selected to concentrate the RF signal on a specific area in the reaction chamber (although it was earlier believed that a smaller head would concentrate the RF to enhance RF heating, a larger reception head was found to generate a higher temperature). Various sizes and shapes of the receiver heads allow for optimal concentration of the RF signal in the seawater.

At block 2014 the transmission head is arranged. Arrangement of the transmission head is accomplished by, for example, placing the transmission head proximate to and on one side of the reaction chamber. At block 2016 the receiver head is arranged. Arrangement of the receiver head is similarly accomplished by, for example, placing the receiver head proximate to and on the other side of the reaction chamber so that an RF signal transmitted via the transmission head to the receiver head will pass through the reaction chamber and be absorbed by the seawater. The transmission head and reception heads are insulated from direct contact with the reaction chamber. The heads may be insulated from the reaction chamber by means of an air gap. Optionally, the heads may be insulated from the target area by means of another insulating material.

The RF frequency(s) may be selected at block 2018. In addition to selecting the desired RF frequency(s) at block 2018, the transmission time or duration may also be selected. The duration time is set to, for example, a specified length of time, or set to raise the temperature of at least a portion of the seawater to boiling. In addition, optionally, other modifications of the RF signal are selected at this time, such as, for example, amplitude, pulsed amplitude, an on/off pulse rate of the RF signal, a variable RF signal where the frequency of the RF signal varies over a set time period or in relation to set temperatures, ranges or changes in temperatures or desired phase transitions.

At block 2020 the RF signal is transmitted from the transmission head to the receiver head. The RF signal passes through the reaction chamber and is absorbed by the seawater contained within the reaction chamber. Absorption of the RF energy results in heating of the seawater causing the seawater to undergo a phase change and produce steam. The steam produced would be free of any salt, minerals, or any other nonvolatile impurities initially present in the seawater.

At block 2022 the steam produced by heating the seawater to boiling is collected. At block 2024 the collected steam is condensed to form purified water. The steam may be collected by any means. An example of a means for collecting and condensing steam would be to utilize a the natural tendency of hot gases, such as steam, to rise. For example, it is contemplated that an exhaust pipe having one end attached to the outlet present in the reaction chamber and positioned to be directly above the reaction chamber could conduct the steam, as it is produced, away from the reaction chamber. It is further contemplated that the other end of the exhaust pipe could be attached to a remotely positioned tank and that this tank would functioned as a condenser such that, upon entering the tank, the steam would cool and convert phases from steam into water. As a result, it is believed that purified water would be condensed and collect in such a condenser tank. It is contemplated that, optionally, the condenser tank could be externally cooled in order to facilitate the rate of condensation of the steam.

The methodology may end at block 2026 and may be ended after a predetermined time interval and/in response to a determination that a desired amount of steam production and desalination has been achieved. The method may be performed once or repeatedly, or continuously, or periodically, or intermittently.

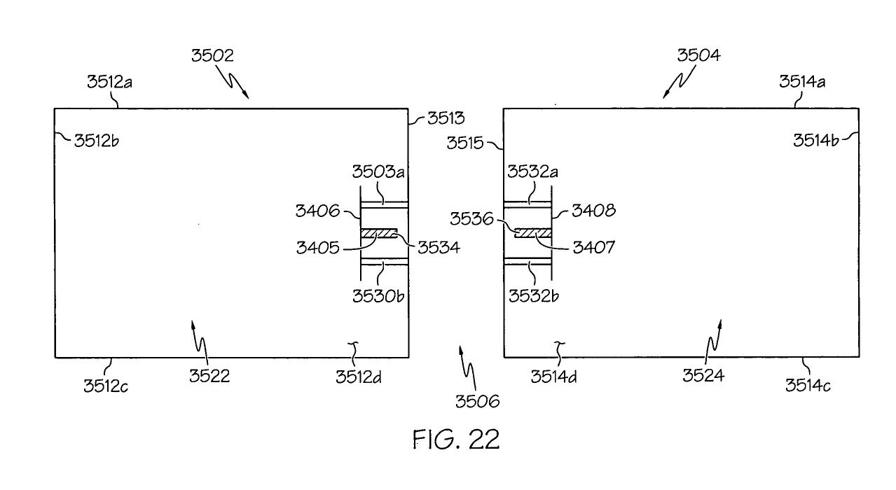

### FIG. 21

FIG. 21 illustrates a high level exemplary methodology 2100 of carrying out the electrolysis of water.

The methodology begins at block 2102. At block 2104 a salt water mixture is provided. The salt water mixture comprises water and at least one salt wherein an effective amount of salt is dissolved in the water. The salt should be water soluble and, in order to effectively form both hydrogen and oxygen gases, the salt should be selected such that the corresponding cation of the salt has a lower standard electrode potential than H⁺ and the corresponding anion of the salt has a higher standard electrode potential than OH⁻. A more detailed description of various salts and their effective amounts which are useful in this regard is given below.

At block 2106 an RF transmitter is provided. The RF transmitter may be any type of RF transmitter generating a suitable RF signal. RF transmitter may be a variable frequency RF transmitter. Optionally, the RF transmitter may also be a multi-frequency transmitter capable of providing multiple-frequency RF signals. Still yet, optionally the RF transmitter may be capable of transmitting RF signals with variable amplitudes or pulsed amplitudes. A variety of different shapes and sizes of transmission and reception heads may be provided.

The transmission head may be selected at block 2108. The selection of the transmission head may be based in part on the type of RF transmitter provided. Other factors, such as, for example, the depth, size and shape of the general target area, or specific target area to be treated, and the number of frequencies transmitted may also be used in determining the selection of the transmission head.

The RF receiver is provided at block 2110. The RF receiver may be tuned to the frequency(s) of the RF transmitter. At block 2112, the desired receiver head may be selected. Similarly to the selection of the transmission head, the receiver head may be selected to fit the desired characteristics of the particular application. For example, a receiver head that is larger than the transmission head can be selected to concentrate the RF signal on a specific area in the reaction chamber (although it was earlier believed that a smaller head would concentrate the RF to enhance RF heating, a larger reception head was found to generate a higher temperature). Various sizes and shapes of the receiver heads allow for optimal concentration of the RF signal in the salt water mixture.

At block 2114 the transmission head is arranged. Arrangement of the transmission head is accomplished by, for example, placing the transmission head proximate to and on one side of the reaction chamber. At block 2116 the receiver head is arranged. Arrangement of the receiver head is similarly accomplished by, for example, placing the receiver head proximate to and on the other side of the reaction chamber so that an RF signal transmitted via the transmission head to the receiver head will pass through the reaction chamber and be absorbed by the salt water mixture. The transmission head and reception heads are insulated from direct contact with the reaction chamber. The heads may be insulated from the reaction chamber by means of an air gap. Optionally, the heads are insulated from the target area by means of another insulating material.

The RF frequency(s) may be selected at block 2118. In addition to selecting the desired RF frequency(s) at block 2118, the transmission time or duration may also be selected. The duration time is set to, for example, a specified length of time, or set to raise the temperature of at least a portion of the salt water mixture to a desired temperature/temperature range, or set to a desired change in temperature. In addition, optionally, other modifications of the RF signal are selected at this time, such as, for example, amplitude, pulsed amplitude, an on/off pulse rate of the RF signal, a variable RF signal where the frequency of the RF signal varies over a set time period or in relation to set temperatures, ranges or changes in temperatures.

At block 2120 the RF signal is transmitted from the transmission head to the receiver head. The RF signal passes through the reaction chamber and is absorbed by the salt water mixture contained within the reaction chamber. Absorption of the RF energy results in decomposition of the salt water mixture to produce hydrogen and oxygen.

At block 2122 both the hydrogen and oxygen produced by decomposition of the salt water mixture is collected. Means for collecting and separating the hydrogen and oxygen produced by the electrolysis of the salt water mixture will be known to those skilled in the art. Such techniques may include using two evacuated, gas collection bells that are nested within one another; where the opening to the innermost gas collection bell is covered with a semi-permeable membrane. The semi-permeable membrane may be made from a material that has a greater permeability to hydrogen gas than it does to oxygen gas. In this regard, as the mixture of hydrogen and oxygen gases are directed using a series of tubes and valves towards the two gas collection bells nested within one another, only hydrogen gas would be able to effectively pass through the membrane covering the innermost gas collection bell. As such, the hydrogen gas would become concentrated in the innermost gas collection bell, while the oxygen gas would become concentrated in the outermost gas collection bell. In this manner, it is believed that the hydrogen gas could be isolated and collected separately from the oxygen gas.

The methodology ends at block 2124 and may be ended after a predetermined time interval and/in response to a determination that a desired amount of hydrogen production has been achieved.

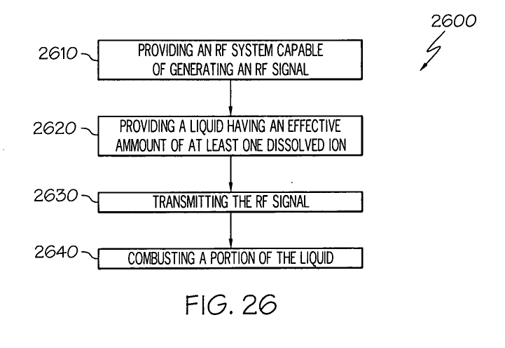

### FIG. 25

FIG. 25 illustrates a high level exemplary methodology 2500 of carrying out the combustion of a liquid. The methodology begins at block 2510. At block 2510 an RF system is provided that is capable of generating an RF signal. The RF system may include an RF generator, transmitter and transmission head and be of the type described above such that it is capable of generating an ignitable gas from sea water in an open container proximate to the transmission head. At block 2520 a liquid is provided that includes an effective amount of at least one ion dissolved in the liquid for generation of an ignitable gas by the RF signal. At block 2530 the RF signal is transmitted such that it interacts with at least some of the liquid. At block 2540 the ignitable gas generated from the liquid by the RF signal is ignited. At block 2550 the methodology ends and may be ended after a predetermined time interval and/in response to a determination that a portion of the liquid has been combusted.

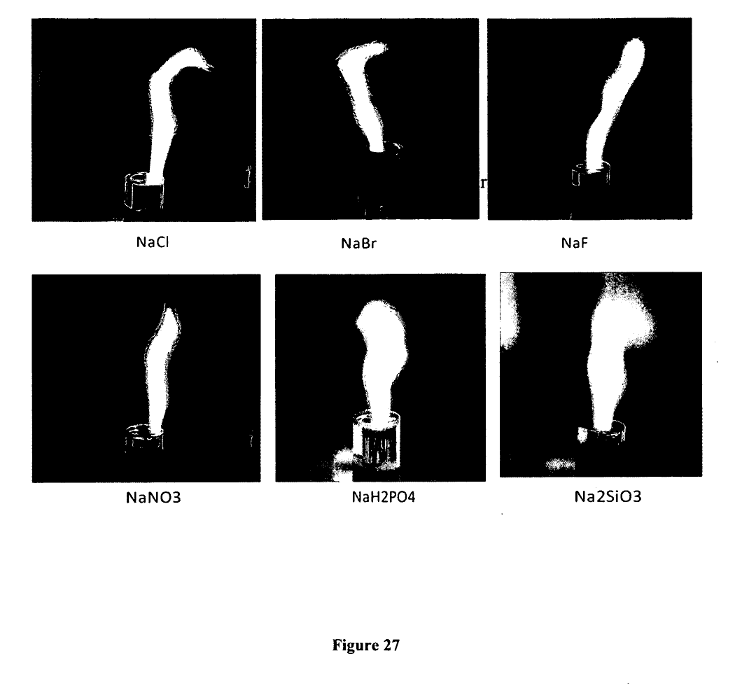

### FIG. 26

FIG. 26 illustrates a high level exemplary methodology 2600 of carrying out the combustion of a liquid. The methodology begins at block 2610. At block 2610 an RF system is provided that is capable of generating an RF signal. The RF system may include an RF generator, transmitter, and transmission head and be of the type described above such that it is capable of generating an ignitable gas from sea water in an open container proximate to the transmission head. At block 2620 a liquid is provided that includes an effective amount of at least one ion dissolved in the liquid for generation of an ignitable gas by the RF signal. At block 2630 the RF signal is transmitted and at block 2640 a portion of the liquid is combusted.

Additional methods are contemplated using the systems described herein where a frequency for operation of the RF signal may be selected such that the frequency is the same as, or overlaps (either partially or completely)—or has harmonics that are the same as or overlaps—specific RF frequencies that are capable of stimulating or exciting any of the various energy levels of various ions, e.g., any of the various metal species that comprise the salts that are dissolved in the salt water solutions. One having ordinary skill in the art will understand how to determine and to measure RF frequencies that stimulate or excite various energy levels for various metal species. In this regard and based on empirical testing, we believe that 13.56 MHz stimulates and/or excites Na ions better than any other ions herein so tested. As such, it is believed that useful embodiments of the methods described herein may therefore also include (i) selecting an RF signal having a preferred frequency, (ii) selecting a metal salt comprising a metal species capable of being stimulated or excited by the preferred frequency selected (or a harmonic thereof), (iii) transmitting the RF signal having the preferred frequency through or to an aqueous solution of the metal salt for a sufficient time in order to stimulate or excite the metal species present in the aqueous solution to generate heat. Alternatively, methods may also include (i) selecting a salt comprising a preferred metal species, (ii) selecting an RF signal having a frequency (or a harmonic thereof) capable of stimulating or exciting the preferred metal species, (iii) transmitting the RF signal having the frequency to or through an aqueous solution of the metal salt comprising the preferred metal species for a sufficient time to generate heat.

Additional methods are contemplated using the systems described herein where the RF signal may be used to process clays and soils to heat and sterilize the clays and soils, to directly generate hydrogen from the clays and soils, and for remediation of the clays or soils by removing or extracting organic contaminants and wastes. It is contemplated, as above, that a frequency for operation of the RF signal may be selected such that the frequency (or a harmonic thereof) is the same as or overlaps with (either partially or completely) specific RF frequencies capable of stimulating or exciting any of the various energy levels of any of the various metal species comprising metal salts or metal compounds that are dissolved or distributed within the soils. Since soils often contain moisture or the metal species present in the soils and clays have water molecules coordinated to them, it is therefore believed that the systems and methods described herein could be used to heat and process such metal-containing soils. As such, we believe the RF signal could be used (in any of the various manners herein described for treatment of salt water solutions) to produced heat and/or steam and/or hydrogen and oxygen free radicals in-situ within various soils, and in particular in clays and clay containing soils. The heat and/or the steam and/or the hydrogen and oxygen free radical produced from the water molecules present in the soil would treat the surrounding soil, in particular the heat and/or the free radicals generated would perhaps sterilize the soil, killing any animal, vegetable or microbial life that may also be present. It is further contemplated that steam produced in-situ in this manner may also be used to volatize and extract any hydrocarbon pollutants that may also be present in the soils and clays. As such, it is contemplated that soils of contaminated commercial residential and industrial sites, hazardous waste dump sites, gas stations, etc. could be remediated using the systems and methods described herein. One skilled in the art will understand how the RF systems and methods described herein could be coupled with known extraction and remediation processes and methods for in-situ treatment of contaminated soils. Exemplary hydrocarbon contaminants that could be extracted or removed would include but are not limited to organic solvents, oil and oil byproducts, insecticides, and polychlorinated biphenyls. Similarly, it is contemplated that clathrates, zeolites, and other materials containing or having various metal species adsorbed to their surfaces or in there structures and containing either moisture or water molecules coordinated to the metal species present may be processed and heated in similar manners as has been described herein for soils and clays.

In accordance with the systems and methods of the present invention previously described, further embodiments are contemplated of an RF system for selective disinfection of surfaces and materials is provided. The system includes an RF transmitter having an RF generator and a transmission head, and an RF receiver having a resonant circuit and a reception head. When the transmission and reception heads are arranged proximate to and on either side of a surface or material and an RF signal is transmitted from the transmission head, through the surface or material, to the reception head, at least a portion of the surface or material is disinfected without direct contact of the heads to the surface or material. It is contemplated, as above, that a frequency for operation of the RF signal may be selected such that the frequency (or harmonic thereof) is the same as or overlaps with (either partially or completely) specific RF frequencies that are capable of stimulating or exciting any of the various energy levels of any of the various metal species or metal salts or metal compounds that may, for example, be present within various targeted microbes, bacteria, or viruses. Since environments where microbes, bacteria, and viruses are found also often contain moisture, we therefore believe that the systems and methods described herein could be used to disinfect surfaces and materials through selectively heating and destroying various targeted microbes, bacteria, and viruses that are present on the surfaces or materials to be disinfected. The RF signal would be applied for a sufficient time to locally heat and destroy any targeted microbes, bacteria, and viruses that contain metals (metals that are either coordinated by water molecules or in an environment containing moisture) that are stimulated or excited by the RF signal having the particular frequency so selected.

In accordance with the systems and methods of the present invention previously described, further embodiments are contemplated of an RF system for affecting a change in the germination and growth of plant life is provided. The system includes an RF transmitter having an RF generator and a transmission head, and an RF receiver having a resonant circuit and a reception head. When the transmission and reception heads are arranged proximate to and on either side of a seed or a plant and an RF signal is transmitted from the transmission head, through the seed or plant, to the reception head, at least a portion of the seed or plant is processed without direct contact of the heads to the seed or plant. For example, a seed may be placed in a brackish environment or a plant may be watered with brine solution and natural biological processes such as osmotic pumping mechanisms may be taken advantage of in order to create a seed or plant having an internal environment with an increased salt concentration. We believe that any of the systems or methods described herein may be used to then expose the so prepared seed or plant to an RF signal, wherein the RF signal would affect a change in the rate of germination of the seed or affect a change in the rate of growth of the plant. We believed that that a frequency for operation of the RF signal may be selected such that the frequency (or harmonic thereof) is the same as or overlaps with (either partially or completely) specific RF frequencies that are capable of either increasing or decreasing the rates of seed germination and plant growth in order to affect such a change in the germination and growth of plant life.

In accordance with the systems and methods of the present invention previously described, further embodiments contemplating RF systems and methods for processing a fluid are provided. Processing a fluid includes but is not limited to heating and/or combusting the fluid. Fluids can be processed whether or not they contain any of the useful salts or ions (either cations or anions) herein described. An exemplary fluid in this regard includes but is not limited to water that is extracted from oil wells and that is contaminated with oil residues and/or other hydrocarbon contaminants. Methods for processing (including heating and/or combusting) a fluid involve using any of the systems previously described and (i) providing a fluid to be processed (including heating and/or combusting the fluid), (ii) adding an effective amount of salt to the fluid (e.g., by adding solid salt or by adding a salt solution), and (iii) passing RF through the fluid containing an effective amount of salt to process the fluid. In general, useful systems may include an RF transmitter having an RF generator and a transmission head, and an RF receiver having a resonant circuit and a reception head. When the transmission and reception heads are arranged proximate to and on either side of the fluid having an effective amount of salt added to it an RF signal is transmitted from the transmission head, through the fluid containing the salt, to the reception head, and at least a portion of the fluid is processed. Processing in this regard may include heating the fluid and/or combusting the fluid and in such situations salt is added to enhance heating of the fluid.

### Salt Water, Salt Water Solutions, and Salt Water Mixtures

Ordinary and naturally occurring seawater may be used. Generally, a salt which is useful as the salt water or in the solution containing salt water or in the salt water mixtures employed in these systems and methods disclosed herein include any salt which has solubility in water. For example, NaCl is a useful salt because NaCl is very soluble in water. Other useful salts may include salts that have as their cation any element in cationic form, which may selected from the group consisting of Li⁺, Na⁺, K⁺, Rb+, Cs⁺, Be²⁺, Mg²⁺, Ca²⁺, Ba²⁺, Sr²⁺, Mn²⁺, Fe²⁺, Fe³⁺, Ni²⁺, Cu²⁺, Zn²⁺, Ag⁺, Au⁺, B³⁺, Al³⁺, Ga³⁺, In³⁺ and that have as the anion any element in anionic form that is selected from the group consisting of Cl⁻, Br⁻, I⁻, borate, citrate, nitrate, phosphate, sulfate, carbonate, and hydroxide. The salt used in the systems and methods disclosed herein can be used as either a pure salt, the salt made from one type of cation and one type of anion that are those cations and anions listed above; or it can be a salt mixture, made from more than one type salt, made from one or more types of cations and/or one or more types of anions that are those cations and anions listed above. Again, ordinary and naturally occurring seawater may be used.

Another useful salt water (or salt water component of either solutions containing salt water or salt water mixtures) for use in the systems and methods disclosed herein is seawater. This includes all types of seawater, including water taken from any of the oceans or other naturally salty bodies of water found on the earth. Using seawater as disclosed herein includes using seawater in its natural occurring form, that is, seawater which is taken from the ocean and used directly without any further processing or purification.

Another useful salt water or salt water solution for use in the systems and methods disclosed herein is brine water. Brine water may be water extracted from the ground (ground water) and includes water that is taken from water wells and oil wells. Using brine water as disclosed herein includes using brine water that has been further processed or treated (for example, by addition of salt, e.g., adding solid salt or a salt solution) or that is in its naturally occurring form and used directly without any further processing or purification.

OCEANIC brand Natural Sea Salt Mix may be used to approximate naturally occurring seawater having an effective amount of salt and used as the salt water or salt water component of solutions containing salt water and salt water mixtures employed in the systems and methods discussed and shown herein. Such approximations of naturally occurring seawater may have a specific gravity of about 1.02 g/cm³ to 1.03 g/cm³, e.g., between about 1.020-1.024 or about 28-32 PPT, as read off of a hydrometer. A mixture of the above-identified sea salt mix having a specific gravity of about 1.026 g/cm³ (as measured with a refractometer) was used in exemplary systems and methods. In the alternative, it is believed that actual seawater may be used in the systems and methods discussed and shown herein. The precise amount of salt in salt water or in the salt water component of the solutions containing salt water and salt water mixtures used and contemplated herein may vary from specific application to specific application.

In order to form both hydrogen and oxygen gas, salts capable of forming salt water mixtures that are useful for use in the electrolysis systems and electrolysis methods disclosed herein, should be water soluble salts and also should have a cation and an anion selected such that the cation has a lower standard electrode potential than H⁺ and the anion has a greater standard electrode potential than OH⁻. For example, the following cations have lower standard electrode potential than H⁺ and are therefore suitable for use as electrolyte cations: Li⁺, Rb⁺, K⁺, Cs⁺, Ba²⁺, Sr²⁺, Ca²⁺, Na⁺, and Mg²⁺. For example, a useful anion would be SO₄²⁻, because it has a greater standard electrode potential than OH⁻ and is very difficult to oxidize. It is contemplated that Na₂SO₄ would be a useful salt for use with the electrolysis systems and methods disclosed here within because it is a water soluble salt that is composed of a cation (Na⁺) that has a lower standard electrode potential than H⁺ and an anion (SO₄²⁻) that has a greater standard electrode potential than OH⁻.

### Additive

As previously indicated, as used herein an additive may be an organic, organometallic, or inorganic chemical compound having solubility, miscibility, or compatibility with salt water and solutions containing salt water and salt water mixtures (including seawater or solutions containing salt water and optionally containing at least one secondary fuel) and that is capable of altering the response of the salt water, various solutions containing salt water, and salt water mixtures in response to stimulation by RF energy. Both molecular and polymeric species are contemplated as being useful additives. It is further believe that useful amounts of additive include solutions containing salt water where the additive is present as at least one minor component in the solution containing salt water. Embodiments contemplated in this regard would include solutions containing salt water and having from about 0.001 to about 10.0 weight % additive, and more preferably from about 0.001 to about 1.0 weight % additive, and even more preferably from about 0.001 to about 0.1 weight % additive.

It is contemplated that a salt water solution or salt water mixture containing an additive will respond differently to RF stimulation versus comparable salt water solution or salt water mixture that does not contain any additive. We believe that the response of a salt water solution or salt water mixture to RF energy may be altered in a variety of ways. For example, an alteration in RF response that an additive may have may include but is not limited to increasing or decreasing the rate at which a solution or mixture containing the additive either heats, combusts, or both upon exposure to a fixed amount or flux of RF energy; exhibiting a desired temperature change or level of combustion of a salt water solution containing an additive with exposure to a larger or a smaller amount of RF energy; and decreasing the surface tension of a salt water solution containing an additive such that combustion of the salt water solution or mixture occurs upon application of an RF field without any need for externally perturbing the surface of the salt water solution. Surfactants, including soaps and detergents, are embodiments of useful additives in this regard since they are known to lower the surface tension of aqueous solutions. Furthermore, we believe that water soluble organic compounds that can lower the heat capacity of an aqueous solution or that can change the freezing point of water or that can form azeotropic mixtures with water would also be useful additives in this regard.

### Secondary Fuels

As previously indicated, as used herein a secondary fuel may be any combustible organic compound that has solubility, miscibility, or compatibility with salt water or various solutions containing salt water or salt water mixtures (including seawater, salt water or solutions containing salt water that optionally contain at least one additive). It is believe that a useful amount of secondary fuel includes solutions containing salt water were the secondary fuel is present as the minor component. Alternatively, it is also believe that a useful amount of secondary fuel includes solutions containing salt or salt water were the secondary fuel is present as the major component. In this regard, embodiments are contemplated of salt water solutions containing from about 0.01 to about 99.99 weight % of at least one alternative fuel, and preferably from about 1.0 to about 99.0 weight % of at least one alternative fuel, and more preferably from about 10 to about 90 weight % of at least one alternative fuel, and even more preferably from about 30 to about 70 weight % of at least one alternative fuel, and even more preferably from about 40 to about 60 weight % of at least one alternative fuel.

It is contemplated that exposure to RF energy of a salt water solution containing at least one secondary fuel, wherein the secondary fuel is the minor constituent, may result in an enhancement or in a boost in performance in terms of the combustibility of the salt water solution versus the results obtained by a comparable salt water solution that does not contain any secondary fuel. Alternatively, it is also contemplated that exposure to RF energy of a salt water solution containing at least one secondary fuel, where the secondary fuel is the major constituent of the mix, allows RF energy to be used to combust the secondary fuel even though the secondary fuel itself may be RF inert. Without intending to be bound by theory, we believe that the secondary fuel may be useful as either the minor or the major component in a salt water solution because the salt water component of the salt water solution is stimulated by the RF signal and absorbs energy. As such, absorption of RF energy by the salt water component causes the temperature of the salt water solution to increase to the point where secondary fuel present in any amount volatilizes and becomes more capability of combusting in the presence of a spark, flame, or any other incendiary source. In this regard, methanol, ethanol, and iso-propanol are useful as secondary fuels because they are combustible organic solvents and are soluble with or have chemical compatibility with water. Furthermore, we believe that many additional organic solvents and compounds, which may have both volatility and solubility or miscibility with aqueous solutions, would also be useful as secondary fuels in this regard. For example, we contemplate that n-propanol, acetone, formaldehyde, acetic acid, and formic acid may also be useful secondary fuels.

### RF Absorption Enhancers

Salt water, solutions containing salt water, and salt water mixtures may be processed using RF as-is. In the alternative, it is also believed that RF absorption enhancers may be added to the salt water, solutions containing salt water, and salt water mixtures prior to processing with RF to enhance the effects of the RF energy on the salt water, e.g., enhanced heating, enhanced, combustion, enhanced desalination, etc. The RF absorption enhancers may be particles made from RF absorbing materials that absorb one or more frequencies of an RF electromagnetic signal substantially more than other materials. This may permit the RF signal to heat salt water (or any solution containing salt water or salt water mixture) containing RF absorbing enhancers substantially more than it would salt water (or salt water solution or salt water mixture) that does not contain additional RF absorption enhancers.

Exemplary RF absorption enhancers include particles of electrically conductive material, such as silver, gold, copper, magnesium, iron, any of the other metals, and/or magnetic particles, or various combinations and permutations of gold, iron, any of the other metals, and/or magnetic particles. Examples of other RF absorption enhancers include: metal tubules (such as silver or gold nanotubes or silver or gold microtubes, which may be water-soluble), particles made of piezoelectric crystal (natural or synthetic), particles made of synthetic materials, particles made of biologic materials, robotic particles, particles made of man made applied materials, like organically modified silica (ORMOSIL) nanoparticles. Examples of yet other RF absorption enhancers that may be useful include RF absorbing carbon molecules and compounds: fullerenes (any of a class of closed hollow aromatic carbon compounds that are made up of twelve pentagonal and differing numbers of hexagonal faces), carbon nanotubes, other molecules or compounds having one or more graphene layers, and other RF-absorbing carbon molecules and compounds e.g., C60 (also known as a “buckyball” or a “buckminsterfullerene”), C70, C76, C84, buckytubes (single-walled carbon nanotubes, SWNTs), multi-walled carbon nanotubes (MWNTs), and other nano-sized or micro-sized carbon cage molecules and compounds. Such carbon-based particles may be in water-soluble form. Such carbon-based particles may have metal atoms (e.g., nickel atoms) integral therewith, which may affect their ability to absorb RF energy and heat in response thereto. Any of the foregoing (and subsequently listed) particles may be sized as so-called “nanoparticles” (microscopic particles whose size is measured in nanometers, e.g., 1-1000 nm) or sized as so-called “microparticles” (microscopic particles whose size is measured in micrometers, e.g., 1-1000 μm).

Additionally, RF absorbing carbon molecules and compounds may be fabricated as RF absorption enhancers to be particles with non-linear I-V characteristics (rectifying characteristics) and/or capacitance. Such non-linear I-V characteristics may result from, for example, nanotubes with a portion doped (e.g., by modulation doping) with a material giving n-type semiconducting properties adjacent a portion doped with p-type semiconducting properties to form a nanotube having an integral rectifying p-n junction. In the alternative, nanotubes can be fabricated with an integral Schottky barrier. In either case, it may be helpful to use nanotubes having at least two conducting regions with a rectifying region therebetween. Accordingly, rectifying circuits for RF absorbing particles for RF absorption enhancers may be fabricated from RF absorbing carbon molecules and compounds having non-linear I-V characteristics.

Any of the RF absorption enhancers described herein may be used alone or in virtually any combination of and/or permutation of any of the particle or particles described herein. For example, it may be beneficial to use a plurality of different RF absorbing particles described herein for purposes of tuning the reaction kinetics of the various methods herein described. Accordingly, virtually any combination or permutation of RF absorption enhancers may be used in virtually any combination of and/or permutation of any RF absorbing particle or particles described herein to create RF absorption enhancers for use in accordance with the teachings herein.

Of the RF absorption enhancers mentioned herein, some may be suitable for a 13.56 MHz RF signal, e.g., silver nanoparticles, gold nanoparticles, copper nanoparticles, magnesium nanoparticles, aqueous solutions of any of the metal sulfates mentioned herein, and RF absorbing carbon molecules and compounds. RF absorption enhancers using these RF absorbing particles are also expected to be effective at slightly higher frequencies, such as those having a frequency on the order of the second or third harmonics of 13.56 MHz.

### RF Signal

The RF signals may have a frequency corresponding to a selected parameter of an RF enhancer, e.g., 13.56 MHz, 27.12 MHz, 915 MHz, 1.2 GHz. Several RF frequencies have been allocated for industrial, scientific, and medical (ISM) equipment, e.g.: 6.78 MHz±15.0 kHz; 13.56 MHz±7.0 kHz; 27.12 MHz±163.0 kHz; 40.68 MHz±20.0 kHz; 915 MHz±13.0 MHz; 2450 MHz±50.0 MHz. See Part 18 of Title 47 of the Code of Federal Regulations. These and other frequencies of the same orders of magnitude may be used in virtually any of the systems and methods discussed herein, depending on which RF absorbing particles are used. For example, RF signals having a fundamental frequency of about 700 MHz or less might be suitable for many of the systems and methods described herein. RF signals having a fundamental frequency in the high frequency (HF) range (3-30 MHz) of the RF range might be suitable for many of the systems and methods described herein. Similarly, RF signals having a fundamental frequency in the very high frequency (VHF) range (30-300 MHz) of the RF range might also be suitable for many of the systems and methods described herein. Of course, RF signals at any fundamental frequency may also have harmonic components that are multiples of the fundamental frequency of frequencies. Also, RF signals at any fundamental frequencies or periodic multiples of such fundamental frequencies that are harmonics of a fundamental frequency may be selected such that the frequency is the same as or has overlap with (either partially or completely) specific RF frequencies capable of stimulating or exciting any of the various electron energy levels of any of the various metal species that comprise the salts that are dissolved in the salt water solutions. For example, based on empirical testing we believe that an RF signal with a frequency of 13.56 MHz stimulates and/or excites Na ions better than any other ions herein so tested.

Additionally, in any of the embodiments discussed herein, the RF signal used may be a pulsed, modulated FM RF signal, or a pulse fixed frequency signal. A pulsed signal may permit a relatively higher peak-power level (e.g., a single “burst” pulse at 1000 Watts or more, or a 1000 Watt signal having a duty cycle of about 10% to about 25%) and may create higher local temperatures at RF absorption enhancer particles. Such pulsed signals may have any of various characteristics. For example, the RF pulse may be a square wave, or may be a sine wave, or may have a sharp rise time with an extended ringing effect at base line, or may have a slow rise time and a fast decay, etc. Pulsed RF signals (and other shaped RF signals) may produce very localized temperatures that are higher for a length of time on the order of about a millisecond or longer. For example, a short 5 kilowatt RF pulse of less than a second, e.g., on the order of microseconds (e.g., 3-4 microseconds) may be sufficient to raise the temperature of the mixture sufficiently to achieve the desired effect, e.g., combustion of the salt water, desalination, heating, creation of hydrogen gas, etc.

As discussed herein, the RF energy directed toward the salt water (or any solution containing salt water, or salt water mixture) may be RF energy having a very high field strength and may also be coupled through the portion of the reaction chamber with coupling heads having a very high Q (e.g., a Q on the order of 250 or more). A pulsed RF signal with a relatively higher power may be effective to quickly heat the salt water, etc., such as a pulse of BF or VHF RF energy (e.g., 27.12 MHz).

### Rate of Combustion

Salt water combusts relatively quickly in a test tube using a 600 Watt 13.56 MHz RF signal. For example, sea water—natural or artificial—combusts in a test tube on the order of about 1 ml per minute initially and later combusts on the order of about 1 ml per every 30 seconds as a substantial amount of water has been combusted from the test tube. In some cases, less salt permits better combustion than more salt. For example, a mixture of 99.5% ethanol and 0.5% salt solution combusts much better (faster) than a 50/50 mixture of ethanol and salt solution (see examples below). As another example, sea water from the Gulf of Mexico combusted at about 2-3 ml per 90 second period at about 1000 watts, using either a 10 ml or 100 ml test tube, with the upper surface of the sea water in the RF field.

### COMPARATIVE EXAMPLES

### Series 1: Experiments with Ocean Water

It was previously demonstrated that salt water made from sea salt mix will combust using the RF system described in the '530 application. It has been confirmed that ocean water will combust using the ENI RF generator using the coupling circuit of FIGS. 46-49 of U.S. Provisional Patent Application Ser. No. 60/915,345, filed on May 1, 2007, and entitled FIELD GENERATOR FOR TARGETED CELL ABLATION (Attorney Docket 30274/04036) (“the '345 application”), the entire disclosure of which is hereby incorporated by reference in its entirety, with a 6″ silver coated circular copper Tx head (single plate) and a 9.5″ silver coated square copper Rx head (single plate).

It is believed that the RF field that combusts salt water is substantially the same as the field discussed in the '345 application (see FIG. 53—end of that application). (It is also believed that Ocean water will combust with the other head configurations discussed in the '530 application, as well.)

With respect to the combustion of ocean water, water from the Gulf of Mexico having the following characteristics was capable of being rapidly combusted with the above-described RF system (a 10 ml sample was analyzed prior to any combustion):

| Parameter | Date of Analysis | Results | Units | Reporting Limit | Method |
|---|---|---|---|---|---|
| Bromide | May 10, 2007 | 57.0 | mg/l | 0.5 | 300.0 |
| Calcium | May 11, 2007 | 970.0 | mg/l | 0.05 | 6010 |
| Chloride | May 10, 2007 | 18552.0 | mg/l | 1.0 | 300.0 |
| Fluoride | May 10, 2007 | BRL | mg/l | 0.1 | 300.0 |
| Magnesium | May 11, 2007 | 1600.0 | mg/l | 0.5 | 6010 |
| pH | May 9, 2007 | 8.02 | s.u.@23.8 C. | 0.01 | EPA 150.1 |
| Potassium | May 11, 2007 | 770.0 | mg/l | 0.1 | 6010 |
| Sodium | May 16, 2007 | 12000.0 | mg/l | 1.0 | 6010 |
| Sulfate | May 10, 2007 | 2633.0 | mg/l | 1.0 | 300.0 |

In this example, combusted ocean water differed from uncombusted ocean water in the concentration of most of these components increases, while the concentration of calcium decreases. Two 10 ml samples of the above water from the Gulf of Mexico were combusted down to 5 ml each and combined, and the resulting 10 ml of combusted ocean water was analyzed to reveal the following:

| | | | | | |
|---|---|---|---|---|---|
| Bromide | May 10, 2007 | 57.0 | mg/l | 0.5 | 300.0 |
| Calcium | May 11, 2007 | 730.0 | mg/l | 0.05 | 6010 |
| Chloride | May 10, 2007 | 20316.0 | mg/l | 1.0 | 300.0 |
| Fluoride | May 10, 2007 | BRL | mg/l | 0.1 | 300.0 |
| Magnosium | May 11, 2007 | 1900.0 | mg/l | 0.5 | 6010 |
| pH | May 9, 2007 | 8.55 | s.u.@22.8 C. | 0.01 | EPA 150.1 |
| Potassium | May 11, 2007 | 880.0 | mg/l | 0.1 | 6010 |
| Sodium | May 16, 2007 | 17000.0 | mg/l | 1.0 | 6010 |
| Sulfate | May 10, 2007 | 3036.0 | mg/l | 1.0 | 300.0 |

A white residue forms on the inside of the test tube after combustion of salt water. The calcium may be part of that residue.

Using the above-described RF system, salt water will combust, as will solutions of HCl and NaCl. Distilled water will boil in the RF field, but will not combust. Adding additional sea salt mix (e.g., OCEANIC brand Natural Sea Salt Mix) to ocean water causes the rate of combustion to increase. Adding sea salt mix sufficient to approximately triple the sodium of ocean water causes a dramatic increase in the rate of combustion of the resulting salt water mixture. Thus, the methods herein may be modified by including the additional step of adding additional ions to the sea water prior to combustion.

Salt water (ocean water and/or salt water made from OCEANIC brand Natural Sea Salt Mix) will begin to combust in the above-described RF system at RF wattages of about 250 Watts and salt water will continue to combust at lower wattages, e.g., about 200 Watts, after igniting. Salt water may begin to combust spontaneously at higher temperatures, or may require some sort of igniter (e.g., a drop of salt water dropped through the RF field, which combusts and ignites the other salt water in the field). Additionally, some sort of wick (e.g., a piece of paper towel) extending above the surface of the salt water in the field will greatly increase the tendency of salt water in the RF field to spontaneously ignite. Filling the test tube to the brim with salt water and then adding a couple more drops of salt water facilitates ignition.

Using a setup with about 5.5″ spacing between Tx plate and Rx plate, and the test tube being about 2″ from the Tx plate at about the top of the Tx plate, and applying RF to the salt water, the products produced from exposure of salt water to RF energy burn. The temperature of the burning products of salt water exposed to RF energy has been measured as high as about 1700° C. using a FLIR Systems ThermaCAM P65 thermometer with ThermaCAM Quick View V2.0 Software, which measures temperatures up to 1700° C. (it is believed that the salt water is combusting at a higher temperature). Surprisingly, the temperature of the salt water in the test tube remains relatively low (e.g., less than 45° C.) while the salt water is combusting.

Without intending to be bound by this description, it is believed that the special RF field generated by the above-described RF system causes hydrogen in salt water to separate from oxygen, and then the hydrogen is burned in the presence of the released oxygen and the oxygen in the surrounding air.

Heat from RF-induced combustion of salt water may be used in any of the traditional methods of gathering and using heat, e.g., a heat exchanger, a Stirling Engine, a turbine system, etc.

Additionally, multiple Tx and Rx heads may be used at one or more frequencies.

### Series 2: Experiments with Salt Water and Solutions with Additives and Secondary Fuels

For all the Series 2 examples described below, a circuit implementation of FIG. 16 was used to transmit the RF signal through the exemplary solutions to yield the various results. Unless otherwise indicated, for all examples a 13.56 MHz RF signal from an ENI OEM-12B RF generator having a variable power output of up to about 1000 Watts was applied for thirty seconds to the reaction chamber, which in these instances consisted of a glass test tube (in which the various exemplary solutions were placed) connected to a support arm that was positioned such that the test tube was suspended between the transmission head (one plate) and the reception head (three plates). Unless otherwise indicated, the salt water solutions used in carrying out the various examples included Gulf of Mexico salt water, Brine salt water extracted from an oil well (located in Erie, Pa.), and a 3.5 wt % stock solution of OCEANIC brand Natural Sea Salt Mix having a specific gravity of about 1.026 g/cm³. For all examples containing ethanol, denatured, Apple Products® brand ethanol was used.

### Salt Water

A first 100 mL sample containing salt water was placed in a test tube and the test tube was then attached to a support arm and positioned between the transmission head and receiver head of the RF apparatus (described above). The temperature of the salt water was measured using a fiber optic thermometer. A 13.56 MHz RF signal at about 300 Watts was then applied for about 30 seconds, after which the temperature was again measured using a fiber optic thermometer. Starting temperature=24.0° C.; Ending temperature=25.9° C.

A second 100 mL sample of salt water was placed in a test tube and the test tube was then attached to a support arm and positioned between the transmission head and receiver head of the RF apparatus (described above). The temperature of the salt water was measured using a fiber optic thermometer. A 13.56 MHz RF signal at about 600 Watts was then applied and, as soon as the RF signal was applied, combustion of the salt water was initiated by momentarily placing an ordinary steel screwdriver in contact with the lip of the test tube. The screw driver was removed and the RF signal was left on for about 30 seconds as combustion of the salt water continued. After about 30 seconds, the RF signal was turned off and the combustion of the salt water ceased. The temperature of the salt water sample was then measured using a fiber optic thermometer at both the top part of the test tube and the bottom part of the test tube. Starting temperature=20.5° C.; Ending temperature (Top)=66.0° C.; Ending temperature (Bottom)=28.0° C.

A third 100 mL sample of salt water was placed in a test tube and the test tube was then attached to a support arm and positioned between the transmission head and receiver head of the RF apparatus (described above). However, the salt water used here contained 1 mL of stock salt water diluted to 100 mL with distilled water to give a 0.0035% salt water solution. A 13.56 MHz RF signal at about 600 Watts was then applied for about 30 seconds, after which the temperature was again measured using a fiber optic thermometer. Unlike the second sample of salt water, combustion of this third sample of salt water could not be initiated by placing an ordinary steel screwdriver in contact with the lip of the test tube. Starting temperature=26.6° C.; Ending temperature=75.5° C.

Salt Water+Carbonate and/or CO₂ (as the “Additive”)

Carbon dioxide may be useful as an additive, as may other additives that produce carbon dioxide. Photographs 9-11 of the incorporated material show the combustion of ground water—here a sample of brine water collected from an oil well (located in Erie, Pa.), while photograph 12 of the incorporated material shows the combustion of a sample of brine water obtained from the Gulf of Mexico. We have observed that the brine water obtained from the Gulf of Mexico combusts in a less sporadic manner than brine water collected from the oil well located in Erie, Pa. Without intending to be bound by theory, we believe high levels of carbonate salts present in the brine water collected from the oil well located in Erie, Pa., that is not present in the brine water collected from the Gulf of Mexico, effects the combustibility of the brine water collected from the oil well located in Erie, Pa. We further believe that, as the brine water collected from the oil well located in Erie, Pa. combusts carbonate salts that are present release carbon dioxide into the sample which acts to suppress or limit further combustion of the brine water as the RF signal is applied. Therefore, additional embodiments are contemplate wherein additives capable of inhibiting combustion or that are combustion suppressants may be added to any of the various salt water solutions herein disclosed in order to control or hinder the rate of salt water combustion or limit the amount of overall combustion.

### Salt Water+Surfactant (as the “Additive”)

A 100 mL sample of salt water that also contained 1 metric drop (about 0.05 mL) of an ordinary hand soap (Liquid Nature Antibacterial Hand Soap) was placed in a test tube and the test tube was then attached to a support arm and positioned between the transmission head and receiver head of the RF apparatus (described above). A 13.56 MHz RF signal at about 600 Watts was then applied to the sample and as soon as the RF signal was applied, combustion of the salt water sample was initiated immediately. No external perturbation of the test tube (by a screwdriver, a drop of salt water, use of a wick or otherwise) was required. The RF signal was repeatedly switched on and off; each time the RF signal was switched on the salt water sample immediately began combusting, while each time the RF signal was switched off the salt water sample immediately ceased combusting.

### Salt Water+Ethanol (as the “Secondary Fuel”)

A first 100 mL sample containing a mixture of 50 mL of ethanol and 50 mL of salt water was placed in a test tube and the test tube was then attached to a support arm and positioned between the transmission head and receiver head of the RF apparatus (described above). A 13.56 MHz RF signal at several hundred Watts was then applied to the sample and, as soon as the RF signal was applied, combustion of the sample was initiated by momentarily placing an ordinary steel screwdriver in contact with the lip of the test tube. Once the RF signal was turned off the combustion of the sample ceased. Surprisingly, in the absence of any applied RF signal combustion of the sample could not be initiated even when an open flame was used to attempt initiation of combustion.

A second 100 mL sample containing a mixture of 99.5 mL of ethanol and 0.5 mL of salt water was placed in a test tube and the test tube was then attached to a support arm and positioned between the transmission head and receiver head of the RF apparatus (described above). The temperature of the salt water was measured using a fiber optic thermometer. A 13.56 MHz RF signal at several hundred Watts was then applied for about 15 seconds, after which the temperature was again measured using a fiber optic thermometer. Starting temperature=26.6° C.; Ending temperature=62.0° C. This example shows that an effective amount of salt (e.g., solid salt or a salt solution) can be added to enhance heating of liquids.

A third 100 mL sample containing a mixture of 99.5 mL of ethanol and 0.5 mL of salt water was placed in a test tube and the test tube was then attached to a support arm and positioned between the transmission head and receiver head of the RF apparatus (described above). The temperature of the salt water was measured using a fiber optic thermometer. A 13.56 MHz RF signal at several hundred Watts was then applied and, as soon as the RF signal was applied, combustion of the sample was initiated by momentarily placing an ordinary steel screwdriver in contact with the lip of the test tube. Combustion of the sample was highly energetic and resulted in a very large flame as compared to RF combustion of a stock solution of salt water that did not contain any ethanol. The screw driver was removed and the RF signal was left on for 15 seconds as energetic combustion of the sample continued. Combustion was so energetic that some of the sample solution bubbled out of the test tube and onto the laboratory floor when it continued to combust. After about 15 seconds, the RF signal was turned off. However, combustion of the sample did not cease and the sample had to be extinguished using a fire extinguisher.

### Control 1: Distilled Water

A 100 mL sample containing distilled water was placed in a test tube and the test tube was then attached to a support arm and positioned between the transmission head and receiver head of the RF apparatus (described above). The temperature of the distilled water was measured using a fiber optic thermometer. A 13.56 MHz RF signal at about 300 Watts was then applied for about 30 seconds, after which the temperature was again measured using a fiber optic thermometer. Starting temperature=24.0° C.; Ending temperature=24.8° C.

### Control 2: Tap Water

A 100 mL sample containing ordinary tap water was placed in a test tube and the test tube was then attached to a support arm and positioned between the transmission head and receiver head of the RF apparatus (described above). The temperature of the ordinary tap water was measured using a fiber optic thermometer. A 13.56 MHz RF signal at about 300 Watts was then applied for about 30 seconds, after which the temperature was again measured using a fiber optic thermometer. Starting temperature=23.7° C.; Ending temperature=47.8° C.

### Control 3: 100% Ethanol

A 100 mL sample containing ethanol was placed in a test tube and the test tube was then attached to a support arm and positioned between the transmission head and receiver head of the RF apparatus (described above). The temperature of the ethanol was measured using a fiber optic thermometer. A 13.56 MHz RF signal at several hundred Watts was then applied for about 15 seconds, after which the temperature was again measured using a fiber optic thermometer. Starting temperature=25.0° C.; Ending temperature=30.0° C.

### Dissociation of Water

In his earlier patent documents, inventor John Kanzius describes a process in which liquid water is dissociated into hydrogen and oxygen using an external RF field. For convenience, this process is referred to in the following paragraphs as the “electromagnetic dissociation of water.” Normally, the electromagnetic radiation is in the form of an RF field generated between a transmission head and a reception head external to the water being dissociated. These earlier patent Kanzius documents also describe various systems and methods for electromagnetic dissociation of water with an external RF field generated by any of various RF systems which may be referred to as Kanzius RF transmitters or Kanzius RF generators.

In conventional electrolysis of water, a direct electrical current in passed through water between two electrodes immersed in the water. At the negatively charged electrode, the cathode, water is reduced according to the following half cell reaction:

2H₂O+2e⁻→H₂+2OH⁻,
thereby liberating hydrogen gas. At the positively charged electrode, or anode, water is oxidized according to the following half cell reaction:

2H₂O→O₂+4H⁺+4e⁻,
thereby liberating oxygen gas.

In the Kanzius electromagnetic dissociation of water, it is believed that the same reactions are occurring, i.e., the dissociation of water into hydrogen and oxygen. However, in the electromagnetic dissociation of water, these reactions occur in response to applied electromagnetic radiation only. Thus, the electromagnetic dissociation of water differs from conventional electrolysis of water in that, in the electromagnetic dissociation of water, alternating electrical energy is applied without electrodes as opposed to applying direct electrical energy with electrodes. Similarly, the electromagnetic dissociation of water differs from other techniques for the direct application of electrical energy such as microwave heating in that, in the electromagnetic dissociation of water, the applied electrical energy causes water in the liquid phase to dissociate into its component parts without substantial heating. In contrast, microwave heating causes substantial heating and eventual evaporation, and is not known to cause direct dissociation of water. The electromagnetic dissociation of water also differs from known techniques for the thermal decomposition (thermolysis) of water which occur in the vapor phase at very high temperatures, with the energy needed for causing the reaction to occur being supplied by conventional heating (e.g., conduction or convection) as opposed to irradiation with electromagnetic radiation. Note, also, that in the Kanzius electromagnetic dissociation of water (as well as the other RF treatments described in this disclosure), no additional energy input such as applied audio signal or an external magnetic field need be applied, and indeed is not normally used.

### Electrolytes

Electrolysis of pure water is impossible to carry out, as a practical matter, because the electrical conductivity of pure water is too low. Therefore an electrolyte, i.e., a substance capable of increasing the electrical conductivity of the water, is added. Ionizable salts are most commonly used for this purpose, the salt chosen normally having a cation with a lower standard electrode potential than H⁺ and an anion with a higher standard electrode potential than OH⁻.

In the electromagnetic dissociation of water, the same additives useful for facilitating conventional electrolysis of water can be included in the water being dissociated here. Thus, any additive capable of increasing the electrical conductivity of water can be added. Many of these additives are described above and in John Kanzius' prior patent documents. For example, this additive may be an ionizable salt having a cation selected from Groups I, II and III of the Periodic Table, as described above, more commonly Groups IA, IIA and IIIA. Essentially any anion capable of producing a soluble salt from such cations can be used, examples of which include chlorides, bromides, fluorides, other halides, nitrates, sulfates, acetates, carbonates, phosphates, carboxylates, sulfates, sulfonates, anions of other organic acids (e.g., acrylates, methacrylates, any other C₃-C₁₂ organic acid, etc.) can be used. Specific examples include NaCl, NaBr, NaF, Na2SO4, NaNO3, Na2(PO4), Na-acetate etc.

Similarly, soluble metal salts and complexes of transition metals such as Cr, Mo, W, Cu, Co, Ni, Fe, Cd, etc. can also be used.

In addition to ionizable salts, other materials can be used as an electrolyte for fostering the electromagnetic dissociation of water, provided they are used in appropriate amounts. For example, as illustrated in the following working examples, aqueous colloidal dispersions of silver particles containing up to about 200 ppm silver readily combusted when irradiated with electromagnetic radiation in accordance with this invention, at least under the particular conditions tried in these examples. Similar colloidal dispersions containing more than about 200 ppm silver did not readily combust, which is believed due to the fact the silver in these colloids had settled out of dispersion as confirmed by visual inspection.

In addition to silver, it is believed that dispersions of other electrically conductive particles will also foster the electromagnetic dissociation of water in accordance with this invention-again, provided they are used in appropriate amounts. Examples of materials which can be used to form such electrically conductive particles include metals, e.g., Cu, Ag, Zn, semi-conductive materials such as TiO₂, ZrO₂, etc., carbon in various forms such as graphite, activated carbon black, etc., and so forth.

In addition to ionizable salts and electrically conductive colloids, still other materials can be used to increase the electrical conductivity of the water being electromagnetically dissociated according to this invention. For example, hydroxyethyl cellulose when added to water in an amount sufficient to produce a gel has been found to foster this electromagnetic dissociation, at least under the conditions used in the following working examples. In addition, various other oxygen and nitrogen-containing organic compounds such as oxalic acid, L-alanine, polyvinyl alcohol, ethyl acetate, ethylene glycol, glycerol, methanol, ethanol and propanol have also been found to foster this electromagnetic dissociation, provided they are used in suitable amounts under appropriate conditions.

In contrast, similar oxygen and nitrogen-containing organic compounds such as formic acid, acetic acid, lauric acid and salicylic acid were found not to foster this electromagnetic dissociation, at least under these same conditions. In the same way, many inorganic materials which do not readily ionize were also found not to foster this electromagnetic dissociation, at least under these same conditions. Examples include boric acid, MS Type 5 Zeolite, quartz, Na-montmorillonite, Ca-montmorillonite, CabOSil (untreated fumed sub-micronometer silica), Plaster of Paris, Kaolinite and Hydrotalcite. All of this merely indicates that, in order to function as an effective electrolyte, an additive needs to have a combination of properties including sufficient solubility in water, effect on the hydrogen/oxygen bond strength of water and other factors so that a not-insignificant increase in the electrical conductivity of water is achieved when the additive is added.

The concentration of the electrolyte included in the water to be electromagnetically dissociated according to this invention is not critical and essentially any amount can be used so long as the electrical conductivity of the solution or dispersion obtained is increased. For ionizable salts, typical amounts include enough to produce solutions which are at least about 0.2 molar up to saturation (for example, for sodium chloride, aqueous solutions of from about 0.3% to about 3% to about 30% combusted, as shown in the working examples, below). For colloidal dispersions of electrically conductive particles, amounts as low as 10 ppm can be used, while concentrations on the order of 20 to 800 ppm, or more especially 30 to 500 ppm, are more typical. For hydroxy ethyl cellulose and its hydroxy C₁-C₁₂ alkyl analogs, essentially the same amounts can be used although amounts suitable for creating a gel are desirable. Greater concentrations of these additives can also be used, since these additives will still impart their electrical conductivity-increasing effect even if present in greater than saturation amounts.

In this connection, it is believed that this aspect of the invention in which water is electromagnetically dissociated will occur in any composition containing free water (i.e., water which is not chemically combined) even if substantial amounts of other ingredients are also present. So, for example, even moist powders can be electromagnetically dissociated, it is believed, since immersion of electrodes in the water being dissociated is unnecessary.

Similarly, it is also believed that concentration of the electrolyte to be included in the water to be electromagnetically dissociated in particular embodiments of this invention also depends on the intensity of the electromagnetic radiation used for the irradiation. As can be seen from the following working examples, some samples showed little or no evidence of dissociation (as reflected by the generation of a combustible gas) when irradiated under the standard conditions used in these examples (600 watts) but did show significant evidence of dissociation when irradiated at higher power levels, e.g., 800 watts or 1000 watts. Accordingly, it should be appreciated that the concentration of the electrolyte to be used in particular embodiments of the electromagnetic dissociation process of this invention depends not only the identity of the particular electrolyte employed but also on the particular irradiations conditions employed as well. These particulars—e.g., the power(s) (and wavelength(s)) of RF signal, the location in the field, and the amount of time of each RF signal transmission, and number of times, needed for effective electromagnetic dissociation of water, or to obtain a desired change result or change in properties of the substances disclosed herein, such as combustion or a shift in Raman spectrum or change in XRD data—can be easily determined by those of ordinary skill in the art by routine experimentation using the teachings in the earlier Kanzius patent documents, and the teachings herein.

Still other aqueous materials that can be electromagnetically dissociated in accordance with this aspect of the invention are the so-called “structured waters,” i.e., microwave distilled deionized water, occasionally referred to as “Sedlmayr” water. See the following patent documents: U.S. Pat. No. 7,119,312 B2; WO 08020912 A2; US 2007/0095823 A1; US 2006/0289502 A1; US 2006/0006172 A1 and US 2006/0006171 A1.

### Non-Aqueous Materials

In another application of this invention, “non-aqueous” materials are heated by the application of radio frequency electromagnetic radiation, or “RF energy,” i.e., electromagnetic radiation having a lower frequency and a higher wavelength than microwave energy. In this context, “non-aqueous” means compositions in which the water content is so low that electromagnetic dissociation of water will not occur to any significant degree when the composition is irradiated with the RF energy.

Microwave radiation is commonly accepted to have a wave length of less than 1 meter (<1 M) to greater than 1 millimeter (>1 mm) and a corresponding frequency of 300 MHz (3×10⁸ Hz) to 300 GHz (3×10¹¹ Hz). Electromagnetic radiation having wave lengths shorter than 1 millimeter and corresponding frequencies greater than 300 GHz is generally opaque to the atmosphere until the atmosphere becomes transparent again in the infrared and optical window frequency ranges. Electromagnetic radiation having wave lengths longer than 1 meter and corresponding frequencies less than 300 MHz is generally regarded as “radio frequency” electromagnetic radiation or “RF energy.” In accordance with this aspect of the invention, RF energy is used to heat a wide variety of different non-aqueous materials. RF signals having a fundamental frequency of about 250 MHz or less, 200 MHz or less, 150 MHz or less, 100 MHz or less, or even 50 MHz or less, are even more interesting. RF signals having a fundamental frequency in the high frequency (HF) range (3-30 MHz) of the RF range are especially interesting, since living tissue is virtually transparent to RF signals in this range. RF signals in the VHF range (30-300 MHz) are also of interest. Most commonly, the frequencies of such signals will not be below about 2 MHz, although frequencies in the medium frequency (MF) range (3 MHz-300 kHz) and even the low frequency (LF) range (300 kHz-30 kHz) are contemplated. It will be appreciated that these frequencies can also be used in connection with the electromagnetic dissociation of water as described above.

The various frequencies for the Kanzius RF transmitter and the associated methods can be characterized in terms of electron volts (eV): e.g., 3 MHz RF energy may be characterized as photons of 1.24×10⁻⁸ eV; 13.56 MHz RF energy may be characterized as photons of 5.6×10⁻⁸ eV; 30 MHz RF energy may be characterized as photons of 1.24×10⁻⁷ eV; and 300 MHz RF energy may be characterized as photons of 1.24×10⁻⁶ eV. Thus, the Kanzius RF transmitter may be further characterized as an RF transmitter (e.g., any of the configurations and/or characterizations herein such as those directly shown herein and those incorporated herein by reference) that generates low-energy photons (e.g., any one or more of the following: photons on the order of 10⁻⁸ eV, or less than 10⁻⁷ eV, or less than 10⁻⁶ eV, or less than 10⁻⁵ eV, or 5.6×10⁻⁸ eV, or 5½×10⁻⁸ eV, or 1.24×10⁻⁸−1.24×10⁻⁷ eV, or 1.24×10⁻⁸−1.24×10⁻⁶ eV, or 1.24×10⁻⁸−1.24×10⁻⁶ eV, or “about” any of these) that are capable of electromagnetic dissociation of water in various aqueous solutions and/or aqueous suspensions and/or aqueous pastes (and the other non-aqueous substances described herein) without requiring any additional energy input such as an external audio signal or an external magnetic field or current via electrodes. This is, indeed, remarkable since the H—OH bond energy is 5.2 eV.

One type of non-aqueous material that can be heated in this way are organic compounds (liquids, solids and gases), particularly those substituted with oxygen, nitrogen and/or sulfur. For example, various oxygen-containing organic liquids such as organic acids, esters, ketones, aldehydes, alcohols, glycols, carbonates, epoxides, furans, and derivatives, etc. can be heated in this way. Indeed, it is believed that any organic compound containing an —OH radical can be heated in this way. Similarly, various nitrogen containing organic liquids such as amides, amines, amino acids, as well as DNA, RNA and other “nucleic acid related compounds.” In this context, “nucleic acid related compound” means ribonucleic acid compounds (“RNA”) and deoxyribonucleic acid compounds (“DNA”), as well as the nucleotides, nucleosides and heterocyclic amine bases which are the nitrogen-containing precursors of or decomposition products of these RNA and DNA compounds, and mixtures of these compounds. See, for example, pages 1107-1149 of Organic Chemistry, 3^{rd} Edition, by John MaMummy, Brooks/Cole Publishing Company, 1992; Lehninger, Biochemistry, Second Edition, Worth Publishers, Inc., pp. 729-747, © 1975; as well as King et al., Chemistry of Nucleic Acids, Version May 11, 2002, available on the web at http://www.med.unibs.it/˜marchesi/nucleic.html.

Naturally occurring cellulosic materials such as plant leaves, bark, wood, etc. can also be heated. In addition, various carbonaceous materials such as coal, shale oil shale, tar sands, etc., can also be heated.

Another type of non-aqueous material that can be heated in accordance with this invention are inorganic solid materials. For example essentially any mineral, especially those containing combined oxygen, can be heated in this way. Examples include various clays, zeolites, silicas, aluminas and aluminosilicates, e.g., brucite, gibbsite, quartz, bauxite, etc. In addition to naturally occurring minerals, essentially any type of refined inorganic compound (i.e., a compound produced by purifying a naturally occurring mineral) as well as man made inorganic compounds, can be heated to a greater or lesser extent by the RF heating technology of this invention. For example, salts, oxides, bases, oxide complexes such as transition metal complexes, and so forth can be heated.

Another interesting phenomenon achieved by the present invention, at least in some embodiments, is a chemical and/or phase change in the non-aqueous material being irradiated as reflected by a change in its X-ray diffraction pattern. In some instances, such as in the case of hydroxyethyl cellulose both in solid form and contained in water, analysis by Raman Spectroscopy shows that an actual chemical change in the sample occurred, as reflected by a change in the characteristic peaks of its X-ray diffraction pattern. In other instances, only the relative intensities of certain peaks changed, thereby indicating a change in state (e.g., a change in crystal structure) but not a change in chemical identity. Due to the preliminary nature of this work, no conclusions can be drawn at this time other than noting that, at least in some instances, the application of RF energy in accordance with this aspect of the invention is sufficiently intense and powerful to effect a change in state of the non-aqueous materials being treated.

### WORKING EXAMPLES

In order to more thoroughly describe this invention, the following working examples are provided:

### Part 1: Liquid Samples

Liquid samples were suspended in a test tube of standard size and volume in the RF field positioned off-center as shown in the photographs (exact measurement of the position was not determined and there was some play in the exact location, however it was always closer to the coupler). Because the goal was to learn what would or would not combust, little attention has been placed on threshold RF power values, and RF power values were not recorded for a number of samples. Even if the RF values were recorded, those values generally reflect the standard instrument configuration at which the sample was tested and so all that can be ascertained from their values is that Sample X did or did not combust well at that power. In general, if certain samples failed to combust, the power was increased until the threshold for combustion was attained.

Unless otherwise noted, all flames self-extinguished upon turning off the RF field. Those that sustained a flame with the field off were snuffed out with a flame-proof mitt.

Unless otherwise noted, all sample solutions in water were prepared with the de-ionized (DI) water. Most solutions were tested at 3% concentration (as specified in the table). Dilute acid solutions were prepared using 8 drops of the pure acid in the test tube to which DI water was added to fill the tube. All samples were run in standard Pyrex test tubes (tt) unless otherwise noted. Teflon (PTFE) test tubes and Quartz (Q) test tubes were used as noted. The following results were obtained:

TABLE 1
Liquid Samples

| | RF | |
|---|---|---|
| Sample Description, holder | power | Observations [C = combusts] |
| GROUP 1 SALTS- | | |
| THE SODIUM SERIES | | |
| 0.3% NaCl in DI water | | C, |
| 3% NaCl in DI water | | C, |
| 3% NaCl in DI water, PTFE tt | | C, |
| 3% NaCl in DI water, Q tt | | C, |
| 3% NaCl in DI water, pyrex tt | 600 W | C, |
| 30% NaCl in DI water | | C |
| 3% NaF in DI water | 600 W | C |
| 3% NaBr in DI water | 600 W | C |
| 3% NaNO3 in DI water | 600 W | C, cracked tt |
| 3% Na2SiO3 in DI water | 600 W | C |
| 3% NaH2PO4 in DI water | 550 W | C, cracked tt |
| <3% NaCl in D2O, Q tt | | C |
| 3% Na-acetate, in DI water, pyrex tt | | C |
| 3% Na2(CO3) | 600 W | Combusts and flame dies down after a |
| | | short while due to possible release of CO2 |
| 3% Na-oxalate | 600 W | C |
| 3% Na2(SO4) | 600 W | C |
| GROUP 1 SALTS | | |
| 3% KCl in DI water | 600 W | C |
| 2% KCl in DI water | | C |
| 1% KCl in DI water | | C |
| 3% KBr in DI water | 600 W | C |
| 3% KNO3 in DI water | 600 W | C |
| 3% K2(CO3) in DI water | 600 W | Combusts and flame dies down after a |
| | | short while due to possible release of CO2 |
| 3% LiCl in DI water | 600 W | C |
| 3% CsCl in DI water | 600 W | C |
| GROUP 2 SALTS | | |
| 3% MgCl2 in DI water | 600 W | C |
| 3% Mg(NO3)2 in DI water | 600 W | C |
| 3% CaCl2 in DI water | 600 W | C |
| 3% BaCl2 in DI water | 600 W | C |
| 3% Ba(CO3)2 | 600 W | C |
| 3% Sr(NO3)2 in DI water | 600 W | C |
| 3% SrCl2 in DI water | 600 W | C |
| 3% Ca(CO3)2 in DI water | 800 W | C, but had trouble igniting at lower power |
| 3% CaH4(PO4)2 in DI water | 600 W | C |
| GROUP 3, 4, 5 (representatives) | | |
| 3% Al(NO3)3 in DI water | 600 W | C |
| 3% Pb(NO3)2 in DI water | 600 W | C |
| 3% Bi(NO3)3 in DI water | 600 W | C |
| TRANSITION METAL SALTS | | |
| 3% Cr(NO3)3 in DI water | 600 W | C |
| 3% Fe(NO3)2 in DI water | 600 W | C |
| 3% Co(NO3)2 in DI water | 600 W | C, cracked tt |
| 3% Ni(NO3)2 in DI water | 600 W | C, cracked tt |
| 3% Ni(OH)2 in DI water | 600 W | C, but sparingly soluble in water |
| 3% CuSO4 in DI water | 600 W | C |
| 3% La(NO3)3 in DI water | 600 W | C |
| 3% Ag(NO3) in DI water | 600 W | C |
| 3% Cd(CH3COO)2 in DI water | 600 W | C |
| INORGANIC ACIDS | | |
| Dilute HCl | 600 W | C |
| Dilute H2SO4 | 600 W | C |
| Dilute HNO3 (3 drops in DIw) | 600 W | C |
| H3PO4 in pyrex tt | 600 W | C |
| 3% H2SiO3 in DI water | 800 W | C |
| H2BO3 (Boric acid) solid | | No Combustion |
| 3% H2O2 | | C |
| STRUCTURED WATERS | | |
| Yuri Kronn's Spring Water | n/a | No combustion |
| (“Rejuvenation Energy in Spring Water” | | |
| commercially-available from Cedar | | |
| Canyon Artesian Well, Forest Grove, | | |
| OR) | | |
| Yuri Kronn's Mineral Water | n/a | C |
| (“Rejuvenation Energy In Trace | | |
| Minerals” commercially available from | | |
| Cedar Canyon Artesian Well, Forest | | |
| Grove, OR) | | |
| Sedlmayr Machine3-A1 water (from a | n/a | C |
| machine in SedlMayr U.S. Pat. No. | | |
| 7,119,312) | | |
| Sedlmayr Machine3-new water (from a | n/a | C |
| machine in SedlMayr U.S. Pat. No. | | |
| 7,119,312) | | |
| Pure DI water (control) | | No combustion |
| Tap water from PSU MRL | Up to | No combustion, but getting ready to boil |
| | 800 | |
| MISCELLANEOUS | | |
| Quartz solution | 600 W | No combustion |
| Carbon black in 3% NaCl | 600 W | C, but sparked and crackled quite a bit |
| OTHER INORGANICS | | |
| 3% NaOH | | C |
| <3% NH4OH | Up to | No combustion |
| | 800 | |
| 3% NH4(CO3) | 600 W | C |
| 3% NH4Cl | 600 W | C |
| ORGANICS | | |
| D-Glucose | | C, weakly at higher RF power |
| Sucrose | | |
| Formic Acid | | No combustion, but boiled over |
| Acetic Acid, in mini tt holder | | Inconclusive. No combustion, but |
| | | realized mini-holder may have been |
| | | located too far up and out of the active |
| | | field area; NaCl in same holder and |
| | | location did not ignite |
| Acetic Acid | | No combustion |
| Citric acid diammonium salt | | *see solid samples data below* |
| Laurie Acid | | *see solid samples data below* |
| Oxalic Acid | | C, cracked tt |
| Salicylic Acid solution | 600 W | No combustion - expanded up and nearly |
| | | oozed out of the tt |
| 2-Methoxycrotonic acid | | *see solid samples data below* |
| 3% L-Alanine in DI water | 800 W | C, but had trouble igniting at lower |
| | | power; faint flame |
| Poly-vinyl Alcohol solution | 1200 W | C |
| Poly-vinyl alcohol, PTFE tt | | No combustion but boiled over after field |
| | | was turned off |
| Ethylene Acetate | | C; sustains burn after field is off |
| Ethylene Glycol | | No combustion - though it almost ignites |
| Ethylene Glycol | 1000 W | C |
| Glycerol | | C after increasing RF power; sustained |
| | | flame after field turned off |
| Methanol | 1000 W | C, just barely . . . low thin flame |
| Ethanol | 0 W | EtOH combustion while adding drops of |
| | | 3% NaCl |
| 2-Propanol | | C |
| Acetone | 600 W+ | C, Intensity of flame increases with RF |
| | | power increase |
| n-decane | ~1000 W | No combustion |
| Dodecane | ~1000 W | No combustion |
| LAYERED INORGANICS | | |
| CabOSil | | C |
| CabOSil, PTFE tt | | C |
| COLLOIDAL SILVERS | | |
| ABL's start water* | 800 W | C |
| ABL 10 ppm Ag | 800 W | C |
| ABL 22 ppm Ag | 800 W | C |
| ABL 32 ppm Ag | 800 W | C |
| ABL 200 ppm Ag | High | C but flame does not sustain |
| | power | |
| ABL 200 ppm Ag | 800 W | No combustion, but boiled over, No |
| | | combustion, Note that sample bottle |
| | | showed silver settled to the bottom and |
| | | hence the sample may not be considered |
| | | as a colloid hence inconclusive data. |
| ABL 400 ppm Ag | 800 W | No combustion, Note that sample bottle |
| | | showed silver settled to the bottom and |
| | | hence the sample may not be considered |
| | | as a colloid hence inconclusive data. |
| ABL 200 ppm Ag, PTFE tt | | C, but not sustained . . . then flame went |
| | | out and it boiled over |
| ABL 410 ppm Ag, PTFE tt | | No combustion, but overflowed from |
| | | nearly boiling and turned brownish |
| GR water w 20 ppm Ag | 1000 W | C |
| GR water w 32 ppm Ag | 1000 W | C |
| GR water w Zinc colloid | 1000 W | C |

*“ABL” refers to reverse osmosis water from American Biotech Laboratories
**GR” refers to reverse osmosis water from General Resonance Corp.

### Part 2: Solid Samples

Irradiation of the solid samples identified in the following Table 2 with Code A was done with the sample contained in a mini-holder having 5 ml volume capacity. After a series of runs on the first few samples, it was determined that this arrangement was not optimal, and so we conclude that most of this data is less than reliable. Nonetheless, it is reported here for the sake of completeness.

Irradiation of the solid samples identified in the following Table 2 with Code B was done using a standard ceramic crucible to hold the powder and pellet samples. A temperature sensor was dipped into the samples to register their temperature changes. All of the samples were positioned and run identically at 600 watts RF power for 2 minutes each, and their temperature rises were recorded. Sample mass varied—most of the time the crucible was filled ¾ of the way, but there were a few samples for which there was only a very small amount, so data was taken on what was available. Nonetheless, this data is believed to be more reliable, as the object of these experiments was only to discern gross effects.

Additional structural data from Raman spectroscopy and x-ray diffraction analysis of select samples is presented in the Attachment hereto. The following results were obtained

TABLE 2
Solid Samples

| | | RF | |
|---|---|---|---|
| Sample Description, holder | Code | power | Observations [C = combusts] |
| INORGANICS | | | |
| Mg(OH)2 | A | | No combustion |
| Ca(OH)2 | A | | No combustion |
| Al(OH)3 | A | | No combustion. T went upto 170 F. |
| AlOOH. xH2O | A | | No combustion. Temperature up with |
| | | | field on; field off at T = 122 F. |
| ORGANICS | | | |
| D-Glucose (anhydrous) | A | | No combustion. Slow temperature rise; |
| dry | | | T = 77 F. at field off |
| Sucrose | A | | No combustion. Temperature rose slowly with |
| | | | the field on: T = 76 F. at field off |
| Citric acid diammonium | A | | No combustion. Slow temperature rise; |
| salt | | | T = 74 F. at field off |
| Na-oxalate, mini holder | A | | No combustion. VERY slow rise in temperature |
| L-2-Alanine | A | | No combustion |
| Poly-vinyl alcohol | A | | No combustion |
| LAYERED | | | |
| INORGANICS | | | |
| Na-Montmorillonite | A | | No combustion. |
| Ca-Montmorillonite | A | | No combustion. |
| CabOSil | A | | No combustion. |
| Plaster of Paris | A | | No combustion. |
| Kaolinite | A | | No combustion. |
| Hydrotalcite | A | | No combustion. |
| Al2O3 | B | | T rises upto 97.4° C. in 2 min |
| Y2O3 | B | | No significant temp rise |
| Hydroxyl ethyl cellulose | B | | T rises upto 89.9° C. in 2 min |
| LaPO4: Ce, Tb | B | | T, Peaked upto 210° C. in 1.30 min then |
| | | | drops to 180 C. |
| CuO | B | | T rises upto 111° C. in 2 min |
| B4C | B | | Slow increase up to 39.7° C. |
| Crystalline silica | B | | Slow increase up to 28° C. |
| Cellulose from crashed | B | | Slow increase up to 42.2° C. |
| leaf | | | |
| Lead Manganese | B | | Slow increase up to 27° C. |
| Niobate pellet | | | |
| LiNbOS pellet | B | | Slow increase up to 27.8° C. |
| Doped ZnS, EL blend | B | | Slow increase up to 30.8° C. |

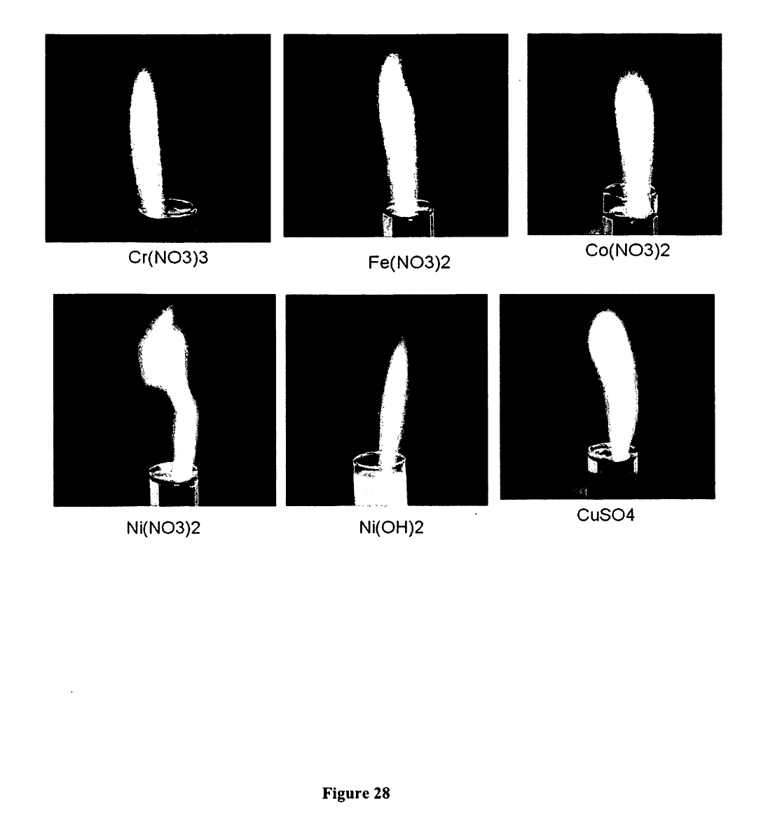

Additional structural data from x-ray diffraction analyses of selected samples subjected to RF irradiation according to this invention, as well as photographs showing combustion of the gas product generated by the electromagnetic dissociation of water in accordance with this invention, are shown in FIGS. 27-36.

FIG. 27 shows that water containing a variety of different sodium salts, when electromagnetically dissociated according to this invention, produces a gas product that readily combusts.

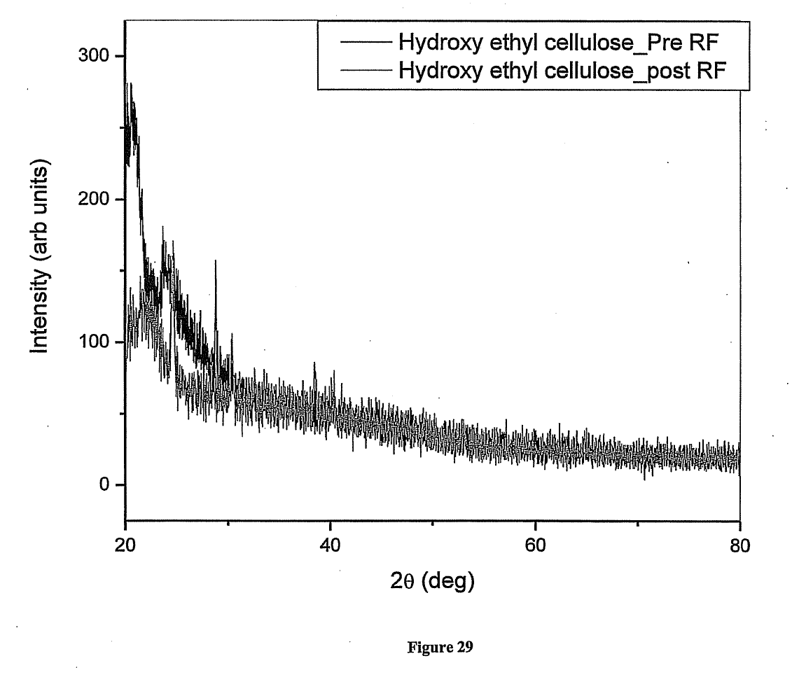

FIG. 28 shows the same result occurring with water containing a variety of different transition metal salts.

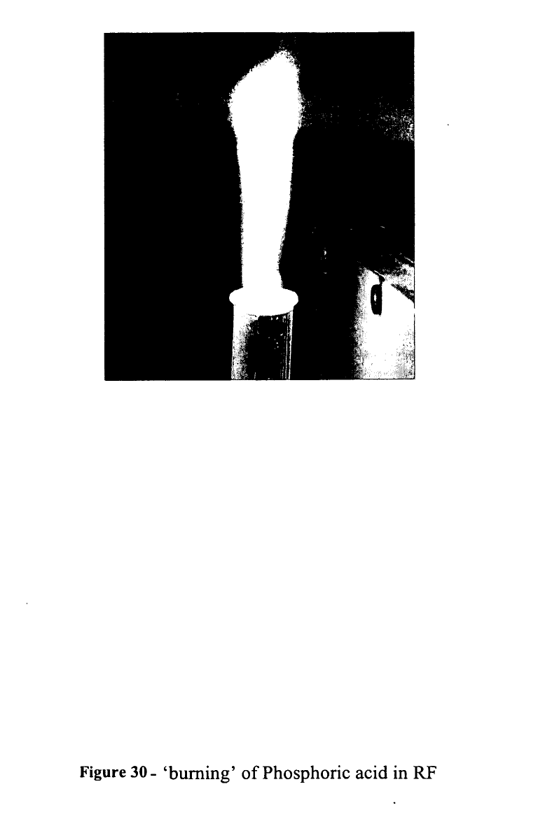

FIG. 29 shows an XRD pattern on hydroxyethyl cellulose irradiated with RF energy in accordance with this invention, both before and after irradiation.

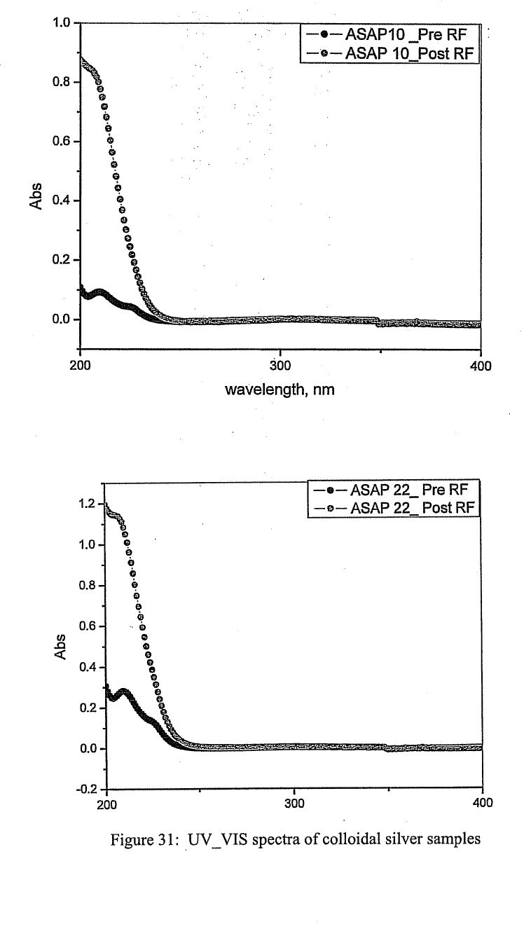

FIG. 30 is a view similar to FIGS. 1 and 2 showing that water containing phosphoric acid also produces a combustible product gas when subjected to RF energy in accordance with this invention.

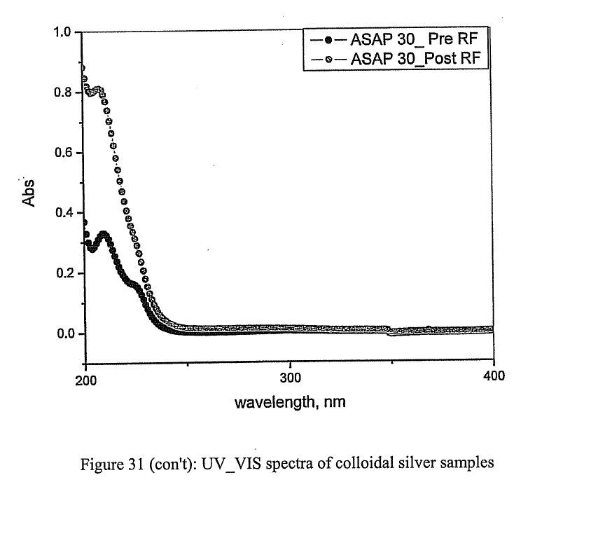

FIG. 31 illustrates UV-VIS spectra of a group of aqueous colloidal silver samples containing different amounts of silver, both before and after irradiation.

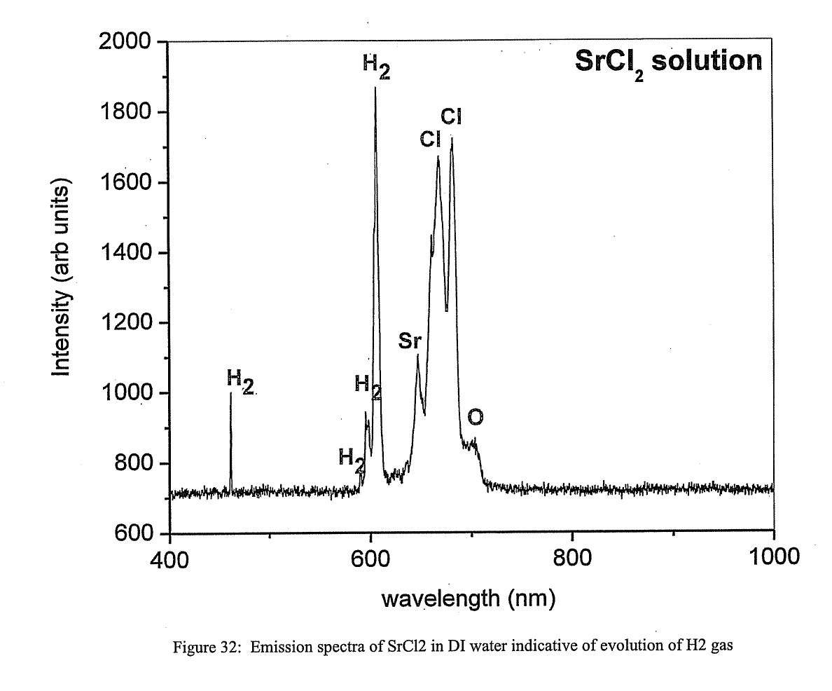

FIG. 32, which is an emission spectra of SrCl₂ in DI water, indicates that combustible H2 gas has been produced.

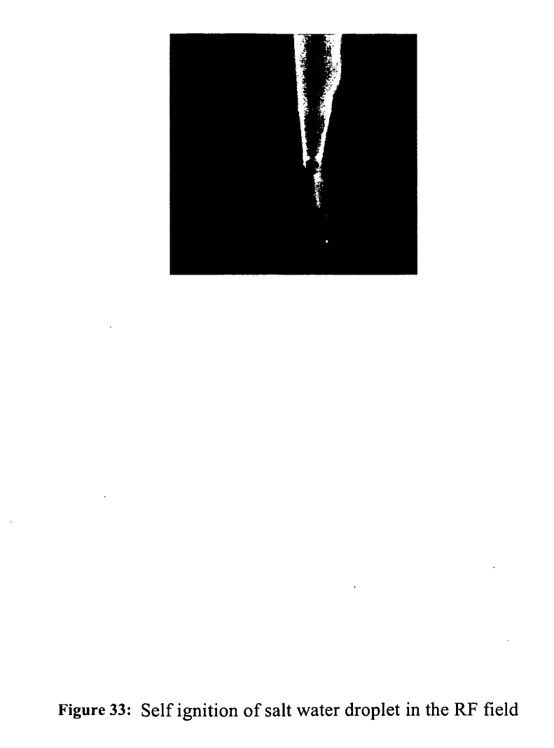

FIG. 33 illustrates the self ignition of salt water droplets in an RF field of this invention. Water droplets containing many other electrolytes described above also self combusts in this way.

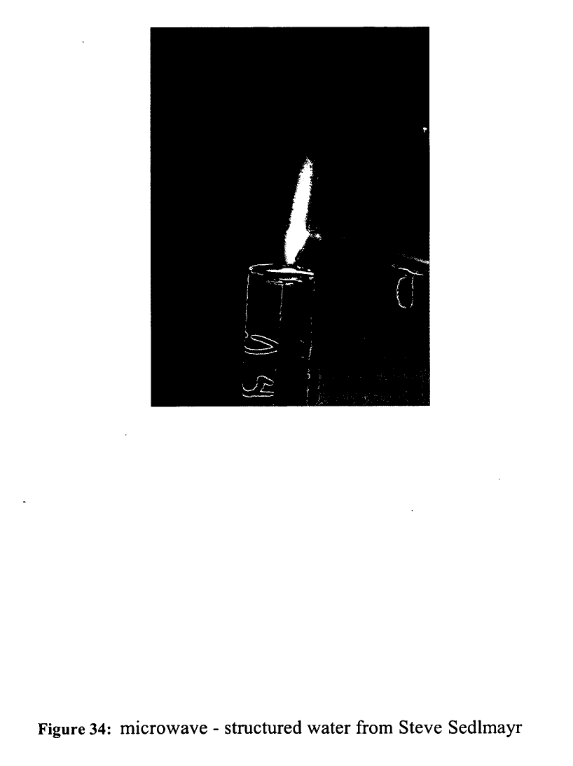

FIG. 34 shows that structured water produced according to U.S. Pat. No. 7,119,312 of Steve Sedlayer also readily combusts when subjected to RF energy in accordance with this invention.

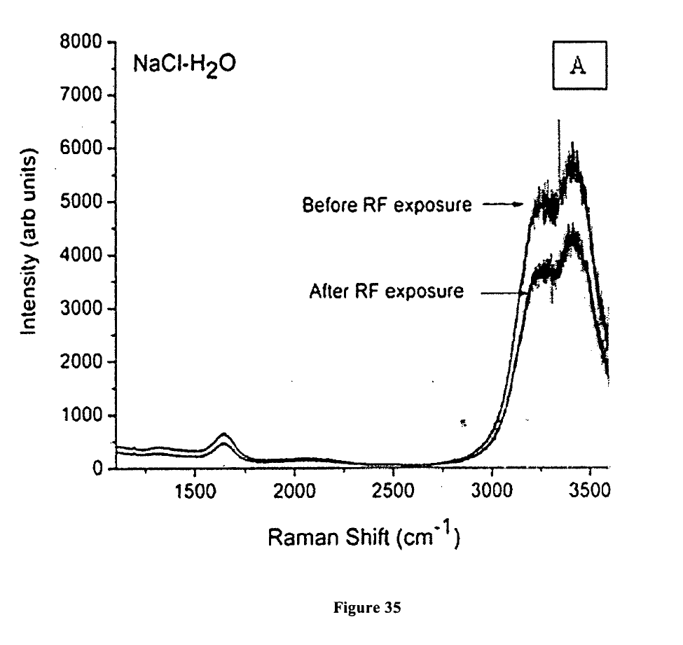

FIG. 35 shows the Raman Spectra of an NaCl-containing sample irradiated with RF energy in accordance with this invention, both before and after irradiation.

These figures further illustrate that irradiation with RF energy in accordance with this invention produces a significant change in the materials being irradiated.

Although only a few embodiments have been described above, many changes and additions can be made without departing from the spirit and scope of the invention. All such embodiments are intended to be included within the scope of the present invention.

TABLE A
EXEMPLARY COMPONENT SPECIFICATIONS

| Fig # | RF Gen | C₁ | C₂ | C₃ | L₁ | L₂ | FP₁ | FP₂ |
|---|---|---|---|---|---|---|---|---|
| 10 | N/A | Capacitor | Air | Vacuum | Coil ¼″φ | Coil ¼″φ | N/A | N/A |
| | | 100 pF, | Variable | Variable | Copper | Copper | | |
| | | 15 kVDC | Capacitor | Capacitor | Tube | Tube | | |
| | | PN: | 36-249 Pf | 12-500 pF | 10 turns | 32 turns | | |
| | | HECHT57Y101MA | 4 kVDC | 15 kVDC, | 2.4″ φ OD | 2.2″ φ OD | | |
| | | QTY: 11 | Surplus | Comet PN | | | | |
| | | | Sales of | CVIC- | | | | |
| | | | Nebraska | 500TN/15 | | | | |
| | | | PN: 12-53 | | | | | |
| 11 | ENI- 240 V | Same as | Same as | Same as | Same as | Same as | 3 plates | N/A |
| | 10-1500 W | FIG. 10 | FIG. 10 | FIG. 10 | FIG. 10 | FIG. 10 | 6″φ . . . | |
| | | | | | | | 0.020″ S.S. | |
| | | | | | | | 0.375″ | |
| | | | | | | | Teflon Spacer | |
| | | | | | | | 4″φ | |
| | | | | | | | 0.020″ S.S | |
| | | | | | | | 0.375″ | |
| | | | | | | | Teflon Spacer | |
| | | | | | | | 3″φ . . . | |
| | | | | | | | 0.020″ S.S. | |
| | | | | | | | Teflon Spacer | |
| 12 | Same as | Same as | Same as | Same as | Same as | Same as | Same as | 3 plates |
| | FIG. 11 | FIG. 10 | FIG. 10 | FIG. 10 | FIG. 10 | FIG. 10 | FIG. 11 | 6″φ . . . |
| | | | | | | | | 0.020″ S.S. |
| | | | | | | | | 0.375″ |
| | | | | | | | | Teflon Spacer |
| | | | | | | | | 4″φ |
| | | | | | | | | 0.020″ S.S |
| | | | | | | | | 0.375″ |
| | | | | | | | | Teflon Spacer |
| | | | | | | | | 3″φ . . . |
| | | | | | | | | 0.020″ S.S. |
| | | | | | | | | Teflon Spacer |
| 16 | Same as | Same as | Same as | Same as | Same as | Same as | 6″ φ × 0.125″ | Same as |
| | FIG. 11 | FIG. 10, | FIG. 10 | FIG. 10 | FIG. 10 | FIG. 10 | thk copper | FIG. 12 |
| | | QTY 13 | | | | | plate | |
| 16a | Same as | Same as | Same as | Same as | Same as | Same as | Same as | 9.5″ silver |
| | FIG. 11 | FIG. 16 | FIG. 10 | FIG. 10 | FIG. 10 | FIG. 10 | FIG. 16 | coated square |
| | | | | | | | | 0.125″ thick |
| | | | | | | | | copper |

1. The electromagnetic dissociation of water.

2. The process of claim 1, wherein the water is electrically conductive.

3. The process of claim 2, wherein the water contains an electrolyte.

4. The process of claim 3, wherein the electrolyte is an ionizable salt.

5. The process of clam 3, wherein the electrolyte is a dispersion of electrically conductive particles.

6. The process of claim 1, wherein the water is irradiated with electromagnetic radiation having a frequency of less than 300 MHz.

7. The process of claim 6, wherein the frequency is less than 200 MHz.

8. The process of claim 7, wherein the frequency is about 3-30 MHz.

9. The process of claim 6, wherein the water is irradiated with photons having an energy of 10⁻⁶ eV or less.

10. The process of claim 6, wherein the water is irradiated with photons having an energy of 10⁻⁷ eV or less.

11. The process of claim 6, wherein the water is irradiated with photons having an energy of 10⁻⁸ eV or less.

12. Heating a material by irradiating the material with RF energy having a frequency of less than 300 MHz.

13. The process of claim 12, wherein the frequency is less than 200 MHz.

14. The process of claim 13, wherein the frequency is about 3-30 MHz.

15. The process of claim 12, wherein the material is irradiated with photons having an energy of 10⁻⁶ eV or less.

16. The process of claim 15, wherein the material is irradiated with photons having an energy of 10⁻⁷ eV or less.

17. The process of claim 16, wherein the material is irradiated with photons having an energy of 10⁻⁸ eV or less.
